(19) United States
(12) Patent Application Publication
(10) Pub. No.: US 2021/0026981 A1
(43) Pub. Date: Jan. 28, 2021

(54) METHODS AND APPARATUSES FOR PROCESSING DATA REQUESTS AND DATA PROTECTION

(71) Applicant: BEIJING DIDI INFINITY TECHNOLOGY AND DEVELOPMENT CO., LTD., Beijing (CN)

(72) Inventor: Xudong ZHANG, Beijing (CN)

(73) Assignee: BEIJING DIDI INFINITY TECHNOLOGY AND DEVELOPMENT CO., LTD., Beijing (CN)

(21) Appl. No.: 17/067,685

(22) Filed: Oct. 10, 2020

Related U.S. Application Data
(63) Continuation of application No. PCT/CN2019/081261, filed on Apr. 3, 2019.

(30) Foreign Application Priority Data
Apr. 11, 2018 (CN) 201810320049.3
May 10, 2018 (CN) 201810442347.X

(51) Int. Cl. G06F 21/62; H04L 29/06

(52) U.S. Cl. CPC G06F 21/6218; H04L 63/102

(57) ABSTRACT

The present disclosure relates to methods and apparatuses for processing data requests and data protection. The methods may include receiving a data request transmitted by a data requester, the data request being used to request to acquire a data resource; determining whether the data requester has a permission to acquire the data resource; and prohibiting a server to respond to the data request, if the data requester has no permission to acquire the data resource.

### CROSS-REFERENCE TO RELATED APPLICATIONS

This application is a continuation of International Patent Application No. PCT/CN2019/081261, filed on Apr. 3, 2019, which claims priority to Chinese Patent Applications No. 201810320049.3 filed on Apr. 11, 2018 and No. 201810442347.X filed on May 10, 2018, the contents of each of which are hereby incorporated by reference.

### TECHNICAL FIELD

The present disclosure generally relates to the technical field of Internet applications, and in particular, to methods and apparatuses for processing data requests and data protection.

### BACKGROUND

With the wide application of Internet technology, Internet-based services (e.g., online to offline (020) services) industries are gradually emerging, and the competition between the industries has become increasingly fierce. The data of the Internet-based service industries may have important reference significance for other industries. In some cases, a malicious user (e.g., a user that intends to acquire the data for malicious purposes, e.g., for copying the data) may pose as a normal user to frequently transmit data requests (or data acquisition requests) to acquire the data. For example, the malicious user may frequently transmit the data requests (or data acquisition requests) to acquire the data through the web crawler technology. In order to protect the data and prevent the data from being acquired by the malicious user, it is desirable to provide methods and apparatuses for processing data requests and data protection.

### SUMMARY

According to an aspect of the present disclosure, a method for processing data requests is provided. The method may be implemented on a computing device having at least one processor, at least one storage device, and a communication platform connected to a network. The method may include receiving a data request transmitted by a data requester. The data request being used to request to acquire a data resource. The method may also include determining whether the data requester has a permission to acquire the data resource. The method may further include prohibiting a server to respond to the data request, if the data requester has no permission to acquire the data resource.

In some embodiments, the determining whether the data requester has the permission to acquire the data resource may include obtaining a suspicious user record that is previously stored; and determining whether the data requester has the permission based on the suspicious user record.

In some embodiments, the determining whether the data requester has the permission to acquire the data resource based on the suspicious user record may include if a user identifier of the data requester is recorded in the suspicious user record, obtaining an occurrence time of a suspicious event corresponding to the user identifier from the suspicious user record; and determining whether the data requester has the permission based on the occurrence time of the suspicious event.

In some embodiments, the determining whether the data requester has the permission based on the suspicious event occurrence time may include determining a current time; determining a suspicious coefficient based on the current time and the occurrence time of the suspicious event; and if the suspicious coefficient is greater than or equal to a preset value, determining that the data requester does not have the permission.

In some embodiments, the suspicious coefficient may be negatively correlated with a target time interval, and the target time interval may be a time interval between the current time and the occurrence time of the suspicious event.

In some embodiments, the method may further include obtaining a data request log for the data resource within a preset time period; determining a suspicious user within the preset time period based on the data request log; and creating or updating the suspicious user record based on the suspicious user within the preset time period.

In some embodiments, the determining the suspicious user within the preset time period based on the data request log may include determining a user, in the data request log, whose number of requests being greater than or equal to a preset number of times, as the suspicious user within the preset time period.

In some embodiments, the determining the suspicious user within the preset time period based on the data request log may further include obtaining, based on the data request log, the number of time period distributions corresponding to data requests generated by candidate users, wherein the number of data requests generated by each of the candidate users is less than the preset number of times; and determining a candidate user, whose number of time period distributions being greater than a first threshold, as the suspicious user within the preset time period.

In some embodiments, the determining the suspicious user within the preset time period based on the data request log may include obtaining, based on the data request log, the number of city distributions corresponding to data requests generated by candidate users, wherein the number of data requests generated by each of the candidate users is less than the preset number of times; and determining a candidate user, whose number of city distributions being greater than a second threshold, as the suspicious user within the preset time period.

According to another aspect of the present disclosure, a method for data protection is provided. The method may be implemented a computing device having at least one processor, at least one storage device, and a communication platform connected to a network. The method may include receiving a data acquisition request transmitted by a device. The method may also include determining M data items to be acquired by the device based on the data acquisition request. The method may also include generating a replacement data item corresponding to each of N data items in the M data items, wherein N is less than or equal to M, M and N are positive integers. The method may further include transmitting N replacement data items to the device.

In some embodiments, the generating the replacement data item corresponding to each of the N data items in the M data items may include determining L types of fields of each of the N data items; collecting at least two original data items, each of the least two original data items including at least one of the L types of fields; and generating the replacement data item based on fields included in the at least two original data items, wherein the replacement data item includes the L types of fields, and a content corresponding to at least one of the L types of fields of the replacement data item is different from a content corresponding to the same type of field of a corresponding data item of the N data items. L may be a positive integer.

In some embodiments, the generating the replacement data item based on the fields included in the at least two original data items may include selecting the L types of fields from the fields included in the at least two original data items; and generating the replacement data item by combining contents corresponding to the L types of fields in the at least two original data items, respectively.

In some embodiments, if N is less than M, the method further include transmitting M-N data items to the device.

In some embodiments, the method may further include determining a weight value of each of the M data items based on the number of times that each of the M data items is accessed; and determining the M-N data items based on the weight values.

In some embodiments, the data acquisition request may include a device identifier of the device, the method may further include determining whether the device identifier is in a preset blacklist before the determination of the M data items to be acquired by the device based on the data acquisition request.

In some embodiments, the transmitting the N replacement data items to the device may include transmitting a data acquisition response to the device, the data acquisition response including the N replacement data items.

According to yet another aspect of the present disclosure, an apparatus for processing data requests including at least one storage device, at least one processor in communication with the at least one storage device is provided. The apparatus may include a receiving module configured to receive a data request transmitted by a data requester, the data request being used to request to acquire a data resource. The apparatus may also include a first determination module configured to determine whether the data requester has a permission to acquire the data resource. The apparatus may further include a prohibiting module configured to prohibit a server to respond to the data request, if the data requester has no permission to acquire the data resource.

According to yet another aspect of the present disclosure, an apparatus for data protection including at least one storage device, at least one processor in communication with the at least one storage device is provided. The apparatus may include a receiving module used to receive a data acquisition request transmitted by a device. The apparatus may also include a determination module used to determine M data items to be acquired by the device based on the data acquisition request. The apparatus may also include a generation module used to generate a replacement data item corresponding to each of N data items in the M data items, wherein N is less than or equal to M, M and N are positive integers. The apparatus may further include a transmission module used to transmit N replacement data items to the device.

According to yet another aspect, a non-transitory computer readable storage medium is provided. The non-transitory computer readable storage medium may store computer programs. When executed by a processor, the method for processing data requests described above may be implemented.

According to yet another aspect, a non-transitory computer readable storage medium is provided. The non-transitory computer readable storage medium may store computer programs, and the computer programs may cause a server to perform the method for data protection described above.

According to yet another aspect, an electronic device is provided. The electronic device may include a storage device, a processor and computer programs stored in the storage device and running on the processor. When the computer programs are executed by the processor, the method for processing data requests described above is implemented.

According to yet another aspect, a server is provided. The server may include a processor, a storage device and computer programs. The computer programs may be stored in the storage device and configured to be executed by the processor, and the computers programs may include instructions used to execute the method for data protection described above.

Additional features will be set forth in part in the description which follows, and in part will become apparent to those skilled in the art upon examination of the following and the accompanying drawings or may be learned by production or operation of the examples. The features of the present disclosure may be realized and attained by practice or use of various aspects of the methodologies, instrumentalities and combinations set forth in the detailed examples discussed below.

### BRIEF DESCRIPTION OF THE DRAWINGS

The present disclosure is further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 is a schematic diagram illustrating an exemplary system according to some embodiments of the present disclosure;

FIG. 2 is a schematic diagram illustrating exemplary hardware and/or software components of a computing device according to some embodiments of the present disclosure;

FIG. 3 a schematic diagram illustrating exemplary hardware and/or software components of a mobile device according to some embodiments of the present disclosure;

FIG. 4 is a block diagram illustrating exemplary data request processing apparatus according to some embodiments of the present disclosure;

FIG. 5 is a flowchart illustrating an exemplary process for processing data requests according to some embodiments of the present disclosure;

FIG. 6 is a flowchart illustrating an exemplary process for processing data requests according to some embodiments of the present disclosure;

FIG. 7 is flowchart illustrating an exemplary process for processing data requests according to some embodiments of the present disclosure;

FIG. 8 is a block diagram illustrating an exemplary data protection apparatus according to some embodiments of the present disclosure;

FIG. 9 is a block diagram illustrating an exemplary data protection apparatus according to some embodiments of the present disclosure;

FIG. 10 is a flowchart illustrating an exemplary process for data protection according to some embodiments of the present disclosure; and

FIG. 11 is a flowchart illustrating an exemplary process for data protection according to some embodiments of the present disclosure.

### DETAILED DESCRIPTION

The following description is presented to enable any person skilled in the art to make and use the present disclosure, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present disclosure is not limited to the embodiments shown, but is to be accorded the widest scope consistent with the claims.

The terminology used herein is for the purpose of describing particular example embodiments only and is not intended to be limiting. As used herein, the singular forms “a,” “an,” and “the” may be intended to include the plural forms as well, unless the context clearly indicates otherwise. It will be further understood that the terms “comprises,” “comprising,” “includes,” and/or “including” when used in this disclosure, specify the presence of stated features, integers, steps, operations, elements, and/or components, but do not preclude the presence or addition of one or more other features, integers, steps, operations, elements, components, and/or groups thereof.

These and other features, and characteristics of the present disclosure, as well as the methods of operations and functions of the related elements of structure and the combination of parts and economies of manufacture, may become more apparent upon consideration of the following description with reference to the accompanying drawing(s), all of which form part of this specification. It is to be expressly understood, however, that the drawing(s) are for the purpose of illustration and description only and are not intended to limit the scope of the present disclosure. It is understood that the drawings are not to scale.

The flowcharts used in the present disclosure illustrate operations that systems implement according to some embodiments of the present disclosure. It is to be expressly understood, the operations of the flowcharts may be implemented not in order. Conversely, the operations may be implemented in inverted order, or simultaneously. Moreover, one or more other operations may be added to the flowcharts. One or more operations may be removed from the flowcharts.

An aspect of the present disclosure relates to methods and apparatuses for processing data requests. According to the present disclosure, the methods and apparatuses may determine whether a data requester has a permission to acquire a data resource by receiving a data requester transmitted by the data requester. The data requester may be used to request to acquire the data resource. If the data requester has no permission to acquire the data resource, the methods and apparatuses may prohibit a server to respond to the data request. The methods and apparatuses may prevent a malicious user from posing as a normal user to frequently transmit data requests (e.g., frequently transmit data requests through the web crawler technology) to acquire the data resource and thus, improving the security of the data resource.

Another aspect of the present disclosure relates to methods and apparatuses for data protection. According to the present disclosure, the methods and apparatuses may receive a data acquisition request transmitted by a device. The methods and apparatuses may then determine M data items (M is a positive integer) to be acquired by the device based on the data acquisition request. The M data items may be real data. The methods and apparatuses may also determine the sender of the data acquisition request (i.e., the user of the device) before the determination of the M data items to be acquired by the device. If the data acquisition request is transmitted by a data acquirer (a user that is not a normal user, e.g., a malicious user), the methods and apparatuses may generate a replacement data item (i.e., false data) corresponding to each of N data items in the M data items (N is a positive integer, and N is less than or equal to M), and transmit N replacement data items (i.e., false data) to the device (or the data acquirer). If N is less than M, the methods and apparatuses may also transmit M-N data item(s) (i.e., real data) to the device. Therefore, the methods and apparatuses may mislead the data acquirer and make the data acquirer fail to identify or need to spend a large cost to identify real or false of the data received by the data acquirer. Thus the methods and apparatuses may improve the effect of data protection.

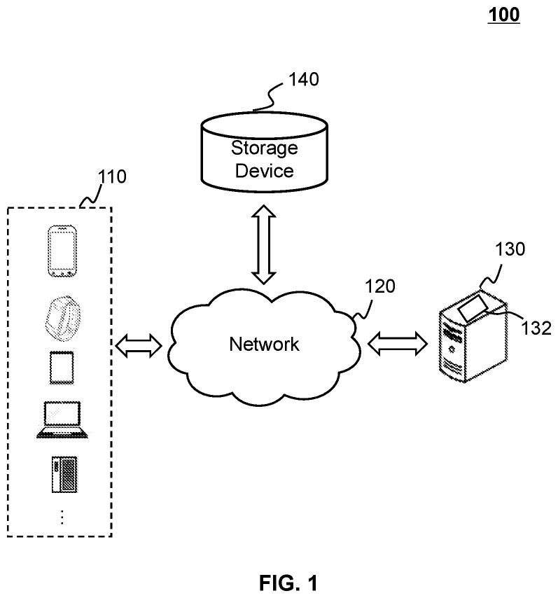

FIG. 1 is a schematic diagram illustrating an exemplary system 100 according to some embodiments of the present disclosure. As shown in FIG. 1, the system 100 may include a terminal device 110, a network 120, a server 130 and a storage device 140. It should be understood that the number or type of the terminal device 110, the network 120, the server 130 and/or the storage device 140 in FIG. 1 are merely illustrative. Depending on the implementation needs, the system 100 may include any number or type of the terminal device 110, the network 120, the server 130 and the storage device 140. Merely by way of example, the system 100 may include a plurality of terminal devices 110.

The terminal device 110 may interact with the server 130 via the network 120 to receive or transmit data (e.g., map data) or information (e.g., a data request). For example, the terminal device 110 may transmit a data request to the server 130 via the network 120. As another example, the terminal device 110 may receive data (e.g., map data) from the server 130 via the network. The terminal device 110 may be various electronic devices, including but not limited to a mobile device, a tablet computer, a laptop computer, a built-in device in a motor vehicle, or the like, or any combination thereof. In some embodiments, the mobile device may include a smart home device, a wearable device, a mobile device, a virtual reality device, an augmented reality device, or the like, or any combination thereof. In some embodiments, the smart home device may include a smart lighting device, a control device of an intelligent electrical apparatus, a smart monitoring device, a smart television, a smart video camera, an interphone, or the like, or any combination thereof. In some embodiments, the wearable device may include a bracelet, footgear, glasses, a helmet, a watch, clothing, a backpack, a smart accessory, or the like, or any combination thereof. In some embodiments, the mobile device may include a mobile phone, a personal digital assistance (PDA), a gaming device, a navigation device, a point of sale (POS) device, a laptop, a desktop, or the like, or any combination thereof. In some embodiments, the virtual reality device and/or the augmented reality device may include a virtual reality helmet, a virtual reality glass, a virtual reality patch, an augmented reality helmet, augmented reality glasses, an augmented reality patch, or the like, or any combination thereof. For example, the virtual reality device and/or the augmented reality device may include a Google Glass™, a RiftCon™, a Fragments™, a Gear VR™, etc. In some embodiments, the built-in device in the motor vehicle may include an onboard computer, an onboard television, etc.

The network 120 may be a medium for providing a communication link among the terminal device 110, the server 130 and the storage device 140. The network 120 may include a variety of connection types, for example, wired or wireless communication link, or a combination thereof. The wired communication link may include, for example, an electrical cable, an optical fiber cable, a telephone wire, or the like, or any combination thereof. The wireless communication link may include, for example, a Bluetooth™ link, a Wi-Fi™ link, a WiMax™ link, a WLAN link, a ZigBee™ link, a mobile network link (e.g., 3G, 4G, 5G, etc.), or the like, or a combination thereof.

The server 130 may be a server that provides various services. The server 130 may provide one or more kinds of services, and the same service may also be provided by multiple servers 130. The server 130 may receive data and/or information, and may process the received data and/or information. The processing may include an analyzing operation, a storing operation, etc. In some embodiments, the server 130 may provide services in response to a service request of a user (e.g., the user of the terminal device 110). For example, the server 130 may receive a data request transmitted by a data requester via, for example, the network 120. The server 130 may further determine whether the data requester has the permission to acquire a data resource (e.g., a data resource stored in the server 130) based on the data request. As another example, the server 130 may receive a data acquisition request transmitted by a data acquirer via, for example, the network 120. The server 130 may generate false data and transmit the false data to the data acquirer based on the data acquisition request. In some embodiments, the server 130 may also transmit control commands or requests to the terminal device 110, the storage device 140, or other servers. For example, the server 130 may transmit an access request to the storage device 140 to obtain data and/or information stored in the storage device 140.

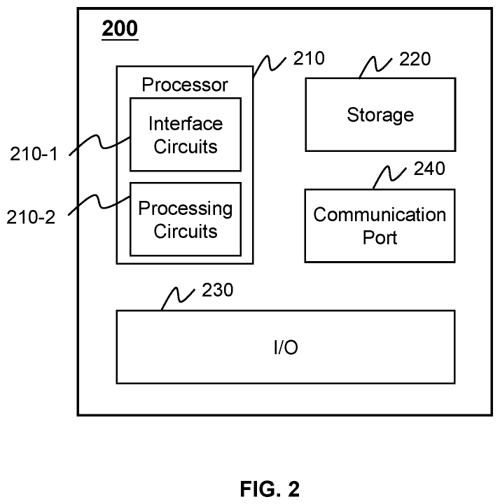

In some embodiments, the server 130 may be may be a single server or a server group. The server group may be centralized, or distributed (e.g., the server 130 may be a distributed system). In some embodiments, the server 130 may be local or remote. For example, the server 130 may access information and/or data stored in the terminal device 110 and/or the storage device 140 via the network 120. As another example, the server 130 may be directly connected to the storage device 140 to access stored information and/or data. In some embodiments, the server 130 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof. In some embodiments, the server 130 may be implemented on a computing device 200 having one or more components illustrated in FIG. 2 in the present disclosure.

In some embodiments, the server 130 may include a processing device 132. The processing device 132 may process information and/or data relating to the services provided by the server 130. For example, the processing device 132 may determine whether a data requester has the permission to acquire a data resource. In some embodiments, the processing device 132 may include one or more processing engines (e.g., single-core processing engine(s) or multi-core processor(s)). Merely by way of example, the processing engine 132 may include one or more hardware processors, such as a central processing unit (CPU), an application-specific integrated circuit (ASIC), an application-specific instruction-set processor (ASIP), a graphics processing unit (GPU), a physics processing unit (PPU), a digital signal processor (DSP), a field-programmable gate array (FPGA), a programmable logic device (PLD), a controller, a microcontroller unit, a reduced instruction-set computer (RISC), a microprocessor, or the like, or any combination thereof. In some embodiments, the processing device 132 may be implemented on a computing device 200 having one or more components illustrated in FIG. 2 in the present disclosure.

The storage device 140 may store data and/or instructions. In some embodiments, the storage device 140 may store data obtained from the terminal device 110. In some embodiments, the storage device 140 may store data and/or instructions that the server 130 may execute or use to perform exemplary methods described in the present disclosure. In some embodiments, the storage device 140 may include a mass storage, a removable storage, a volatile read-and-write memory, a read-only memory (ROM), or the like, or any combination thereof. Exemplary mass storage may include a magnetic disk, an optical disk, a solid-state drive, etc. Exemplary removable storage may include a flash drive, a floppy disk, an optical disk, a memory card, a zip disk, a magnetic tape, etc. Exemplary volatile read-and-write memory may include a random access memory (RAM). Exemplary RAM may include a dynamic RAM (DRAM), a double date rate synchronous dynamic RAM (DDR SDRAM), a static RAM (SRAM), a thyristor RAM (T-RAM), and a zero-capacitor RAM (Z-RAM), etc.

Exemplary ROM may include a mask ROM (MROM), a programmable ROM (PROM), an erasable programmable ROM (EPROM), an electrically erasable programmable ROM (EEPROM), a compact disk ROM (CD-ROM), and a digital versatile disk ROM, etc. In some embodiments, the storage device 140 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof.

In some embodiments, the storage device 140 may be connected to the network 120 to communicate with one or more components of the system 100 (e.g., the server 130, the terminal device 110). One or more components in the system 100 may access the data or instructions stored in the storage device 140 via the network 120. In some embodiments, the storage device 140 may be directly connected to or communicate with one or more components in the system 100 (e.g., the server 130, the terminal device 110). In some embodiments, one or more components in the system 100 (e.g., the server 130, the terminal device 110) may have permission to access the storage device 140. In some embodiments, the storage device 140 may be part of the server 130.

FIG. 2 is a schematic diagram illustrating exemplary hardware and/or software components of a computing device 200 according to some embodiments of the present disclosure. In some embodiments, the computing device 200 may be used to implement one or more components of the system 100. For example, the server 130 (or the processing device 132 of the server 130) may be implemented on the computing device 200 via its hardware, software program, firmware, or a combination thereof. Although only one such computer is shown for convenience, the computer functions related to the service as described herein may be implemented in a distributed manner on a number of similar platforms to distribute the processing load. As illustrated in FIG. 2, the computing device 200 may include a processor 210, a storage 220, an input/output (I/O) 230, and a communication port 240.

The processor 210 (e.g., logic circuits) may execute computer instructions (e.g., program code) and perform functions of the server 130 in accordance with techniques described herein. For example, the processor 210 may include interface circuits 210-1 and processing circuits 210-2 therein. The interface circuits 210-1 may be configured to receive electronic signals from a bus (not shown in FIG. 2), wherein the electronic signals encode structured data and/or instructions for the processing circuits 210-2 to process. The processing circuits 210-2 may conduct logic calculations, and then determine a conclusion, a result, and/or an instruction encoded as electronic signals. Then the interface circuits 210-1 may send out the electronic signals from the processing circuits 210-2 via the bus.

The computer instructions may include, for example, routines, programs, objects, components, data structures, procedures, modules, and functions, which perform particular functions described herein. For example, the processor 210 may determine whether a data requester has a permission to acquire a data resource. In some embodiments, the processor 210 may include one or more hardware processors, such as a microcontroller, a microprocessor, a reduced instruction set computer (RISC), an application specific integrated circuits (ASICs), an application-specific instruction-set processor (ASIP), a central processing unit (CPU), a graphics processing unit (GPU), a physics processing unit (PPU), a microcontroller unit, a digital signal processor (DSP), a field programmable gate array (FPGA), an advanced RISC machine (ARM), a programmable logic device (PLD), any circuit or processor capable of executing one or more functions, or the like, or any combinations thereof.

Merely for illustration, only one processor is described in the computing device 200. However, it should be noted that the computing device 200 in the present disclosure may also include multiple processors, thus operations and/or method steps that are performed by one processor as described in the present disclosure may also be jointly or separately performed by the multiple processors. For example, if in the present disclosure the processor of the computing device 200 executes both step A and step B, it should be understood that step A and step B may also be performed by two or more different processors jointly or separately in the computing device 200 (e.g., a first processor executes step A and a second processor executes step B, or the first and second processors jointly execute steps A and B).

The storage 220 may store data/information obtained from the terminal device 110, the storage device 140, and/or any other component of the system 100. In some embodiments, the storage 220 may include a mass storage, a removable storage, a volatile read-and-write memory, a read-only memory (ROM), or the like, or any combination thereof. For example, the mass storage may include a magnetic disk, an optical disk, a solid-state drives, etc. The removable storage may include a flash drive, a floppy disk, an optical disk, a memory card, a zip disk, a magnetic tape, etc. The volatile read-and-write memory may include a random access memory (RAM). The RAM may include a dynamic RAM (DRAM), a double date rate synchronous dynamic RAM (DDR SDRAM), a static RAM (SRAM), a thyristor RAM (T-RAM), and a zero-capacitor RAM (Z-RAM), etc. The ROM may include a mask ROM (MROM), a programmable ROM (PROM), an erasable programmable ROM (EPROM), an electrically erasable programmable ROM (EEPROM), a compact disk ROM (CD-ROM), and a digital versatile disk ROM, etc. In some embodiments, the storage 220 may store one or more programs and/or instructions to perform exemplary methods described in the present disclosure. For example, the storage 220 may store a program for the server 130 for determine whether a data requester has a permission to obtain a data resource.

The I/O 230 may input and/or output signals, data, information, etc. In some embodiments, the I/O 230 may enable a user interaction with the server 130. In some embodiments, the I/O 230 may include an input device and an output device. Examples of the input device may include a keyboard, a mouse, a touch screen, a microphone, or the like, or a combination thereof. Examples of the output device may include a display device, a loudspeaker, a printer, a projector, or the like, or a combination thereof. Examples of the display device may include a liquid crystal display (LCD), a light-emitting diode (LED)-based display, a flat panel display, a curved screen, a television device, a cathode ray tube (CRT), a touch screen, or the like, or a combination thereof.

The communication port 240 may be connected to a network (e.g., the network 120) to facilitate data communications. The communication port 240 may establish connections between the server 130 and the terminal device 110, or the storage device 140. The connection may be a wired connection, a wireless connection, any other communication connection that can enable data transmission and/or reception, and/or any combination of these connections. The wired connection may include, for example, an electrical cable, an optical cable, a telephone wire, or the like, or any combination thereof. The wireless connection may include, for example, a Bluetooth™ link, a Wi-Fi™ link, a WiMax™ link, a WLAN link, a ZigBee™ link, a mobile network link (e.g., 3G, 4G, 5G, etc.), or the like, or a combination thereof. In some embodiments, the communication port 240 may be and/or include a standardized communication port, such as RS232, RS485, etc.

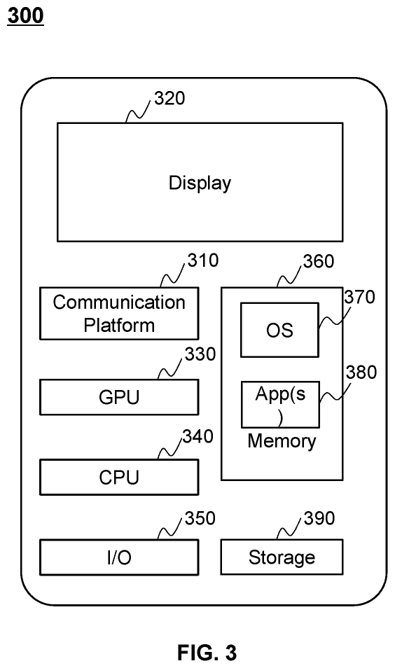

FIG. 3 is a schematic diagram illustrating an exemplary hardware and/or software components of a mobile device 300 according to some embodiments of the present disclosure. In some embodiments, the mobile device 300 may be used to implement one or more components of the system 100. For example, the terminal device 110 may be implemented on the mobile device 300. As illustrated in FIG. 3, the mobile device 300 may include a communication platform 310, a display 320, a graphic processing unit (GPU) 330, a central processing unit (CPU) 340, an I/O 350, a memory 360, and a storage 390. In some embodiments, any other suitable component, including but not limited to a system bus or a controller (not shown), may also be included in the mobile device 300. In some embodiments, a mobile operating system (OS) 370 (e.g., iOS™, Android™, Windows Phone™, etc.) and one or more applications 380 may be loaded into the memory 360 from the storage 390 in order to be executed by the CPU 340.

The applications 380 may include a browser or any other suitable mobile apps for receiving and rendering information relating to a service of the server 130 or other information from the server 130, and sending information relating to the service of the server 130 or other information to the server 130. User interactions with the information stream may be achieved via the I/O 350 and provided to the server 130 and/or other components of the system 100 via the network 120.

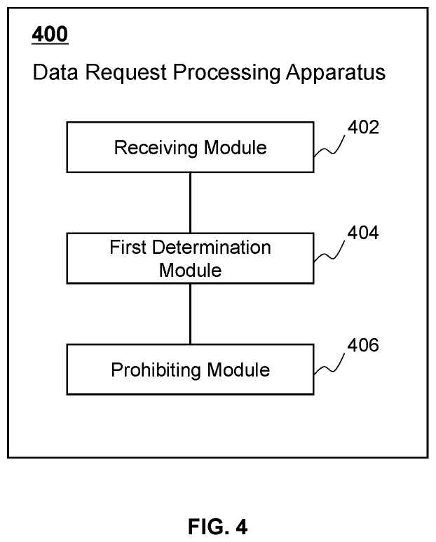

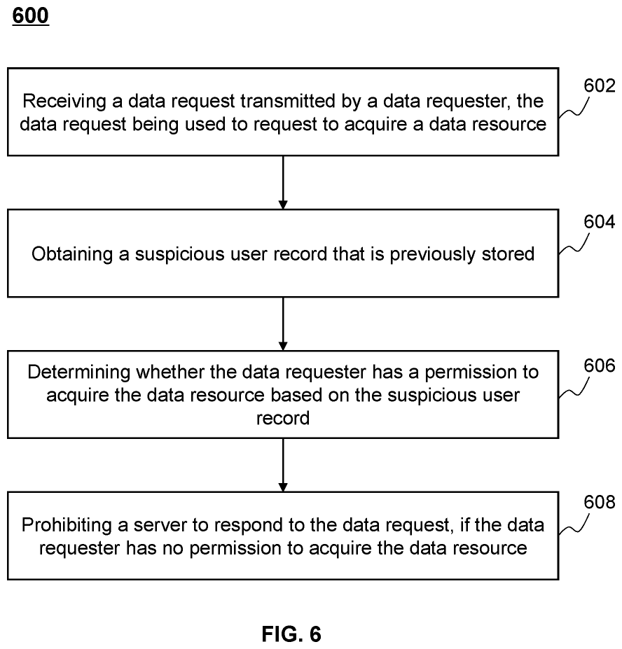

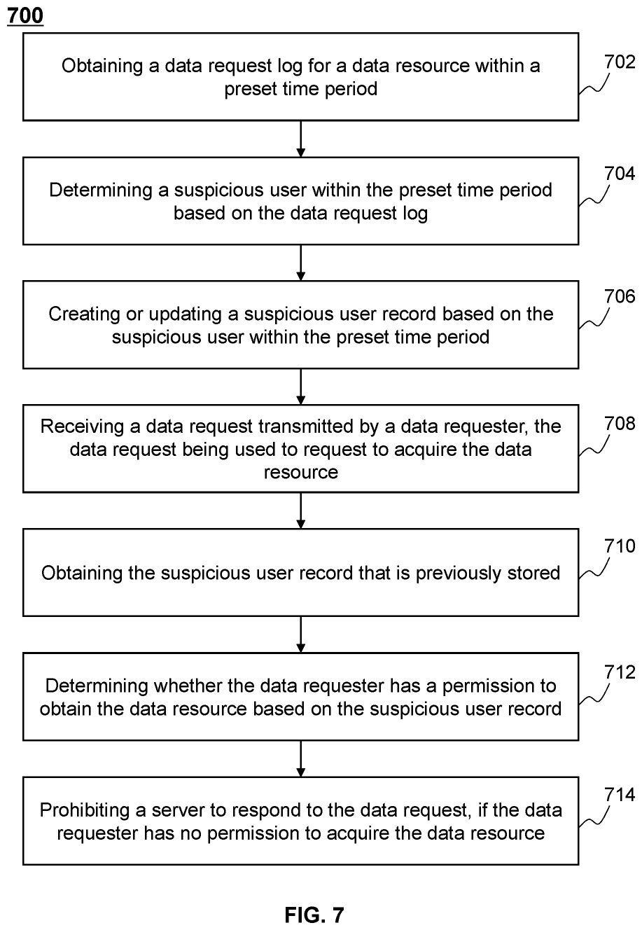

FIG. 4 is a block diagram illustrating an exemplary data request processing apparatus 400 according to some embodiments of the present disclosure. In some embodiments, the data request processing apparatus 400 may be part of the server 130. In some embodiments, the data request processing apparatus 400 may be preset in the server 130, or may be loaded into the server 130 by downloading or the like. Corresponding modules or units in the data request processing apparatus 400 may cooperate with modules or units in the server 130 to implement a scheme for processing data requests. In some embodiments, the data request processing apparatus 400 may be an implementation of the processing device 132. In some embodiments, the data request processing apparatus 400 may be implemented on the computing device 200 illustrated in FIG. 2, via its hardware, software, or a combination thereof. In some embodiments, the data request processing apparatus 400 may be used to perform the process for processing data requests illustrated in FIGS. 6-7. As shown in FIG. 4, the data request processing apparatus 400 may include a receiving module 402, a first determination module 404 and a prohibiting module 406.

The receiving module 402 may be configured to receive a data request transmitted by a data requester. The data request may be used to request to acquire a data resource. In some embodiments, the data request may include a user identifier of the data requester. The user identifier of the data requester may include an identification (ID) of the data requester, a communication number (e.g., a telephone number) of the data requester, etc.

The data requester may be a user requesting to acquire the data resource. In some embodiments, the data requester may be a normal user that requests to acquire the data resource. In some embodiments, the data requester may be a malicious user that intends to acquire the data resource for malicious purpose, e.g., for copying data of the server 130. For example, the malicious user may frequently transmit data requests (e.g., frequently transmit the data requests through the web crawler technology) to request to acquire the data resource of the server 130. In some embodiments, the data requester may transmit the data request for the data resource to the receiving module 402 through the terminal device 110 (e.g., a user interface of the terminal device 110). The receiving module 402 may receive the data request via, for example, the network 120.

The data resource may be stored in the server 130 (e.g., a storage module of the processing device 132 or the data request processing apparatus 400), or in a storage device in communication with the server 130 (e.g., the storage device 140). The data resource may be any form of data resource. For example, taking the 020 service of the vehicle as an example, the data resource may be a map data resource, including but not limited to a data resource of building entrances and exits, a data resource of pick-up points recommendation, a data resource of nearby shops recommendation, etc. In some embodiments, the data resource may include data in any form, such as text data, image data, audio data, video data, etc. The specific content and form of the data resource provided in the present disclosure are merely illustrative, and not intended to be limiting.

The first determination module 404 may be configured to determine whether the data requester has a permission to acquire the data resource. In some embodiments, the first determination module 404 may predetermine a suspicious user based on a data request log for the data resource within a preset time period (e.g., the past day, the past week, etc.), and create or update a suspicious user record. In response to receiving the data request transmitted by the data requester, the first determination module 404 may obtain the suspicious user record that is previously stored. In some embodiments, the first determination module 404 may obtain the suspicious user record from a storage module (not shown) in the data request processing apparatus 400. In some embodiments, the first determination module 404 may obtain the suspicious user record from the storage device 140 via the network 120. The first determination module 404 may then determine whether the data requester has the permission to acquire the data resource based on the suspicious user record. In some embodiments, in response to receiving the data request transmitted by the data requester, the data request processing apparatus 400 may obtain the data request log for the data resource within the preset time period. The first determination module 404 may then directly determine whether the data requester has the permission to acquire the data resource based on the data request log. Detailed descriptions of the determination of whether the data requester has the permission to acquire the data resource may be found elsewhere (e.g., FIG. 6 and/or FIG. 7 and the descriptions thereof) in the present disclosure. It is to be understood that the first determination module 404 may also determine whether the data requestor has the permission to acquire the data resource by other means, and the present disclosure is not intended to be limiting in this aspect.

The prohibiting module 406 may be configured to prohibit the server 130 (or the data request processing apparatus 400) to respond to the data request, if the data requester has no permission to acquire the data resource. If the data requester has no permission to acquire the data resource, the prohibiting module 406 may be prohibited to respond to the data request, and may not return the data resource to the data requester. In some embodiments, if the data requester has the permission to acquire the data resource, the data request processing apparatus 400 may further respond to the data request. The data request processing apparatus 400 may obtain the data resource, and transmit the data resource to the data requester. In some embodiments, the data request processing apparatus 400 may obtain the data resource from a storage module in the data request processing apparatus 400. In some embodiments, the data request processing apparatus 400 may obtain the data resource from the storage device 140 or an external storage device via the network 120.

The data request processing apparatus 400 provided by the above embodiments of the present disclosure may determine whether the data requester has the permission to acquire the data resource by receiving the data request transmitted by the data requester. The data request may be used to request to acquire the data resource. If the data requester has no permission to acquire the data resource, the data request processing apparatus 400 may be prohibited to respond to the data request. Therefore, it is avoided that a malicious user poses as a normal user to frequently request to acquire important data resources through web crawler technology and thus, improving the security of the data resource.

In some embodiments, the first determination module 404 may further include an obtaining unit and a determination unit (not shown).

The obtaining unit may be configured to obtain a suspicious user record that is previously stored. In some embodiments, the suspicious user record may be previously stored in a storage module (not shown) in the data request processing apparatus 400. The obtaining unit may obtain the suspicious user record from the storage module. In some embodiments, the suspicious user record may be previously stored in the storage device 140. The obtaining unit may obtain the suspicious user record from the storage device 140 via the network 120.

In some embodiments, the suspicious user record may include one or more user identifiers of one or more suspicious users. A user identifier may include an identification (ID), a communication number (e.g., a telephone number, a Wechat™ number), etc. In some embodiments, the suspicious user record may also include one or more occurrence times of suspicious events corresponding to a user identifier. It is to be understood that the suspicious user record may also include other information. The present disclosure is not intended to be limiting in the specific content recorded in the suspicious user record. In some embodiments, the suspicious user record may record the one or more user identifiers and the corresponding one or more occurrence times of suspicious events in the form of, for example, a table. In the present disclosure, a suspicious user may be a malicious user that intends to acquire the data resource for malicious purposes, e.g., for copying data of the server 130. For example, the suspicious user may frequently transmit data requests (e.g., frequently transmit the data requests through the web crawler technology) to request to acquire the data resource of the server 130. The suspicious event corresponding to the suspicious user (i.e., corresponding to the user identifier of the suspicious user) may refer to operations of the suspicious user. The suspicious event may include operations associated with acquiring the data resource of the server 130, for example, an operation of transmitting a data request to request the data resource of the server 130. Detailed descriptions of the suspicious user and the suspicious event may be found elsewhere in the present disclosure (e.g., FIG. 7 and the descriptions thereof).

The determination unit may be configured to determine whether the data requester has the permission based on the suspicious user record.

In some embodiments, the data request transmitted by the data requester may include the user identifier (e.g., the ID, the communication number, etc.) of the data requester. The determination unit may search for the user identifier of the data requester in the suspicious user record. If the user identifier of the data requester is not recorded in the suspicious user record, the determination unit may determine that the data requester has the permission to acquire the data resource. If the user identifier of the data requester is recorded in the suspicious user record, the determination unit may determine that the data requester has no permission to acquire the data resource.

In some embodiments, if the user identifier of the data requester is recorded in the suspicious user record, the determination unit may further obtain an occurrence time of a suspicious event corresponding to the user identifier of the data requester from the suspicious user record. The determination unit may determine whether the data requester has the permission to acquire the data resource based on the occurrence time of the suspicious event.

Specifically, in some embodiments, the determination unit may determine whether the data requester has the permission to acquire the data resource based on the occurrence time of the suspicious event using the following method. Firstly, the determination unit may determine a current time (e.g., a current date, etc.). The determination unit may then determine a suspicious coefficient corresponding to the data requester based on the current time and the occurrence time of the suspicious event (e.g., the occurrence date of the suspicious event). If the suspicious coefficient is less than a preset value, the determination unit may determine that the data requester has the permission to acquire the data resource. If the suspicious coefficient is greater than or equal to the preset value, the determination unit may determine that the data requestor has no permission to acquire the data resource. In some embodiments, the preset value may be default settings of the system 100, or may be adjusted under different situations. Merely by way of example, the preset value may be 0.1, 0.2, 0.3, 0.4, 0.5, etc.

In some embodiments, the suspicious coefficient corresponding to the data requester may be negatively correlated with a target time interval. The target time interval may be a time interval between the current time and the occurrence time of the suspicious event corresponding to the user identifier of the data requester (e.g., the interval between the current date and the occurrence date of suspicious event corresponding to the user identifier of the data requester). For example, the determination unit may determine the suspicious coefficient by the following equation:

$$D = {\sum }_{{T}_{i} ∈ Time ( P )} {2}^{- λ ( {t}_{c} - {T}_{i} )}$$

wherein D represents the suspicious coefficient corresponding to the data requester, Tᵢ represents the occurrence time (e.g., the occurrence date) of the i^{th} suspicious event corresponding to the user identifier of the data requester, Time(P) represents a set of occurrence times of the suspicious events corresponding to the user identifier of the data requester, t_{c} represents the current time, and A represents a preset threshold. In some embodiments, λ may be set as 0.28.

It is to be understood that the determination unit may also determine the suspicious coefficient by any other reasonable equations, and the present disclosure is not intended to be limiting in the specific method of determining the suspicious coefficient.

In some embodiments, the determining unit may further include a time obtaining sub-unit and a permission determination sub-unit (not shown).

The time obtaining sub-unit may be configured to if the user identifier of the data requester is recorded in the suspicious user record, obtain the occurrence time of the suspicious event corresponding to the user identifier from the suspicious user record.

The permission determination sub-unit may be configured to determine whether the data requester has the permission based on the occurrence time of the suspicious event.

In some embodiments, the permission determination sub-unit may be further configured to determine the current time, and determine the suspicious coefficient corresponding to the data requester based on the current time and the occurrence time of the suspicious event. If the suspicious coefficient is greater than or equal to the preset value, the permission determination sub-unit may determine that the data requester has no permission to acquire the data resource.

In some embodiments, the data request processing apparatus 400 may also include an obtaining module and a second determination module (not shown).

The obtaining module may be configured to obtain a data request log for the data resource within a preset time period. The data resource may be stored in the server 130 (e.g., a storage module of the processing device 132 or the data request processing apparatus 400), or in a storage device in communication with the server 130 (e.g., the storage device 140). The data resource may be any form of data resource. For example, taking the 020 service of the vehicle as an example, the data resource may be a map data resource, including but not limited to a data resource of building entrances and exits, a data resource of pick-up points recommendation, a data resource of nearby shops recommendation, etc. In some embodiments, the data resource may include data in any form, such as text data, image data, audio data, video data, etc. The data request log for the data resource may be a log that records information of requesting to acquire the data resource. In some embodiments, the data request log may record user identifiers (e.g., IDs, communication numbers) of users that request to acquire the data resource, the number of data requests generated by the users, time information of the users requesting to acquire the data resource (e.g., the time corresponding to data requests generated by the users), and/or the location information corresponding to the data resource requested by the users, etc.

The preset time period may be any reasonable time period. In some embodiments, the preset time period may be default settings of the system 100, or may be adjusted under different situations. For example, the preset time period may be the past day, the past two days, the past week, the past month, the past two months, etc. The present disclosure is not intended to be limiting in the specific setting of the preset time period. In some embodiments, the obtaining module may obtain the data request log for the data resource within the preset time period from a storage module (not shown) of the data request processing apparatus 400. In some embodiments, the obtaining module may obtain the data request log for the data resource within the preset time period from the storage device 140 via the network 120. In some embodiments, the obtaining module may obtain the data request log for the data resource within the preset time period at regular intervals (e.g., every other day, every two days, every other week, etc.).

The second determination module may be configured to determine a suspicious user within the preset time period based on the data request log. In some embodiments, the suspicious user may be a malicious user that intends to acquire the data resource for malicious purposes, e.g., for copying data of the server 130. For example, the suspicious user may frequently transmit data requests (e.g., frequently transmit the data requests through the web crawler technology) to request to acquire the data resource of the server 130.

In some embodiments, the second determination module may determine a user in the data request log, whose number of requests being greater than or equal to a preset number of times, as the suspicious user within the preset time period. The second determination module may determine a user in the data request log, whose number of requests being less than the preset number of times, as a normal user. As used herein, the term “number of requests” may refer to the number of data requests generated by a user. In some embodiments, the preset number of times may be default settings of the system 100, or may be adjusted under different situations. Merely by way of example, the preset number of times may be 5, 10, 15, etc.

In some embodiments, the second determination module may determine a user in the data request log, whose number of requests being greater than or equal to the preset number of times, as the suspicious user within the preset time period. The second determination module may determine a user in the data request log, whose number of requests being less than the preset number of times, as a candidate user. The second determination module may further determine whether the candidate user is the suspicious user or the normal user. In some embodiments, the second determination module may obtain the number of time period distributions corresponding to data requests generated by candidate users based on the data request log. The number of data requests generated by each of the candidate users may be less than the preset number of times. For example, one hour may be determined as one time period, and one day may be divided into twenty-four time periods. If the data requests generated by candidate user A occur at the time periods corresponding to 7:00, 8:00, 9:00, 11:00, and 13:00, the number of time period distributions corresponding to data requests generated by the candidate A may be five. The second determination module may determine a candidate user, whose number of time period distributions being greater than a first threshold, as the suspicious user within the preset time period. The second determination module may determine a candidate user, whose number of time period distributions being less than the first threshold, as the normal user. In some embodiments, the first threshold may be default settings of the system 100, or may be adjusted under different situations. Merely by way of example, the first threshold may be 5, 10, 15, etc.

In some embodiments, the second determination module may determine the user in the data request log, whose number of requests being greater than or equal to the preset number of times, as the suspicious user within the preset time period. The second determination module may determine a user in the data request log, whose number of requests being less than the preset number of times, as a candidate user. The second determination module may further determine whether the candidate user is the suspicious user or the normal user. In some embodiments, the second determination module may obtain the number of city distributions corresponding to data requests generated by candidate users based on the data request log. The number of data requests generated by each of the candidate users may be less than the preset number of times. For example, if the data requests generated by candidate user B request the data resources located at five cities of Beijing, Shanghai, Shenzhen, Chengdu, and Hangzhou, respectively, the number of city distributions corresponding to data requests generated by the candidate B may be five. The second determination module may determine a candidate user, whose number of city distributions being greater than a second threshold, as the suspicious user within the preset time period. The second determination module may determine a candidate user, whose number of city distributions being less than the second threshold, as the normal user. In some embodiments, the second threshold may be default settings of the system 100, or may be adjusted under different situations. Merely by way of example, the second threshold may be 5, 10, 15, etc.

It is to be understood that the second determination module may also determine the suspicious user within the preset time period by any other reasonable manner. The present disclosure is not intended to be limiting in the specific manner of determining the suspicious user within the preset time period.

In some embodiments, the data request processing apparatus 400 may also include a storage module (not shown). The storage module may be configured to create or update the suspicious user record based on the suspicious user within the preset time period.

In some embodiments, if it is the first time to determine the suspicious user within the preset time period (as illustrated in step 704), the storage module may create and store the suspicious user record. If it is not the first time (e.g., the second time, the third time) to determine the suspicious user within the preset time period, the storage module may update the suspicious user record that has been stored. In some embodiments, the suspicious user record may record/include one or more user identifiers (e.g., IDs, communication numbers) of one or more suspicious users, the occurrence times (e.g., the occurrence dates) of suspicious events corresponding to the one or more user identifiers, etc. In some embodiments, the suspicious user record may record the one or more user identifiers and the corresponding one or more occurrence times of suspicious events in the form of, for example, a table.

In some embodiments, when updating the suspicious user record that has been stored, if the user identifier of a suspicious user that is newly determined has not been recorded in the suspicious user record, the storage module may record the user identifier of the suspicious user and associate the occurrence time (e.g., occurrence date) of the suspicious event with the user identifier of the suspicious user in the suspicious user record. If the user identifier of a suspicious user that is newly determined has already been recorded in the suspicious user record, then the storage module may record the occurrence time (e.g., the occurrence date) of the new suspicious event corresponding to the user identifier of the suspicious user in the suspicious user record.

The modules and/or units in the data request processing apparatus 400 may be connected to or communicate with each other via a wired connection or a wireless connection. The wired connection may include a metal cable, an optical cable, a hybrid cable, or the like, or any combination thereof. The wireless connection may include a Local Area Network (LAN), a Wide Area Network (WAN), a Bluetooth™, a ZigBee™, a Near Field Communication (NFC), or the like, or any combination thereof.

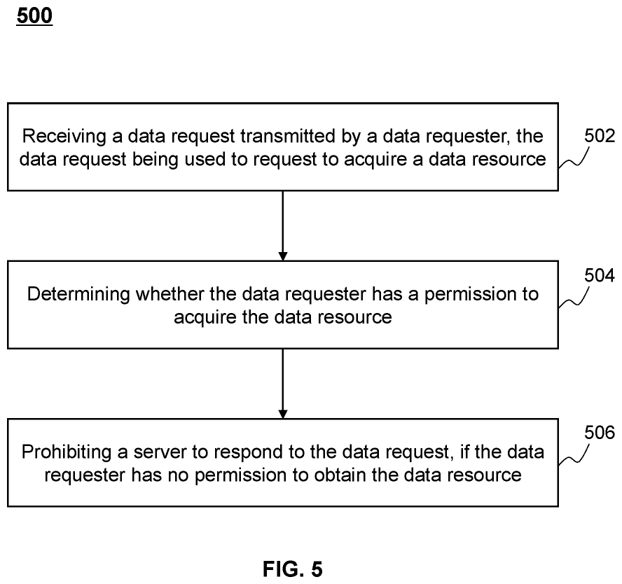

The embodiments of the apparatus are substantially corresponding to the embodiment of the method, and thus reference can be made to partial description of the embodiments of the method. Therefore, more descriptions of the data request processing apparatus 400 may be found elsewhere (e.g., FIGS. 5-7 and the descriptions thereof) in the present disclosure. The embodiments of the data request processing apparatus 400 described above are merely illustrative. The modules and/or units described as separate components may or may not be physically separated, and the components shown as a unit may or may not be a physical unit, which means that they can be located in one place, or distributed to multiple network units. The purpose of the present disclosure may be implemented by selecting some or all of the modules therein according to actual needs. Persons having ordinary skills in the art can understand and carry out the embodiments without further creative efforts.

FIG. 5 is a flowchart illustrating an exemplary process 500 for processing data requests according to some embodiments of the present disclosure. In some embodiments, the process 500 may be implemented in the system 100 illustrated in FIG. 1. For example, the process 500 may be implemented on the server 130 (or the processing device 132 of the server 130). As another example, the process 500 may be implemented on the data request processing apparatus 400. As yet another example, the process 500 may be stored in the storage device 140 and/or the storage 220 as a form of instructions (e.g., an application), and invoked and/or executed by the server 130 (e.g., the processing device 132 of the server 130, the processor 220 illustrated in FIG. 2, or one or more modules and/or units in the data request processing apparatus 400 illustrated in FIG. 4). The operations of the illustrated process presented below are intended to be illustrative. In some embodiments, the process 500 may be accomplished with one or more additional operations not described, and/or without one or more of the operations discussed. Additionally, the order in which the operations of the process 500 as illustrated in FIG. 5 and described below is not intended to be limiting.

In step 502, the server 130 (e.g., the processing device 132, the data request processing apparatus 400, the receiving module 402, the processor 210, and/or the interface circuits 210-1) may receive a data request transmitted by a data requester. The data request may be used to request to acquire a data resource. In some embodiments, the data request may include a user identifier of the data requester. The user identifier of the data requester may include an identification (ID) of the data requester, a communication number (e.g., a telephone number) of the data requester, etc.

The data requester may be a user that requests to acquire the data resource. In some embodiments, the data requester may be a normal user that requests to acquire the data resource. In some embodiments, the data requester may be a malicious user that intends to acquire the data resource for malicious purposes, e.g., for copying data of the server 130. For example, the malicious user may frequently transmit data requests (e.g., frequently transmit the data requests through the web crawler technology) to request to acquire the data resource of the server 130. In some embodiments, the data requester may transmit the data request for the data resource to the server 130 through the terminal device 110 (e.g., a user interface of the terminal device 110). For example, the data requester (i.e., a malicious user) may transmit the data request for the data resource to the server 130 through a web crawler application installed on the terminal device 110. The server 130 may receive the data request via, for example, the network 120.

The data resource may be stored in the server 130 (e.g., a storage module (not shown) in the processing device 132 or the data request processing apparatus 400), or in a storage device in communication with the server 130 (e.g., the storage device 140). The data resource may be any form of data resource. For example, taking the 020 service of the vehicle as an example, the data resource may be a map data resource, including but not limited to a data resource of building entrances and exits, a data resource of pick-up points recommendation, a data resource of nearby shops recommendation, etc. In some embodiments, the data resource may include data in any form, such as text data, image data, audio data, video data, etc. The specific content and form of the data resource provided in the present disclosure are merely illustrative, and not intended to be limiting.

In step 504, the server 130 (e.g., the processing device 132, the data request processing apparatus 400, the first determination module 404, the processor 210, and/or the processing circuits 210-2) may determine whether the data requester has a permission to acquire the data resource.

In some embodiments, the server 130 may predetermine a suspicious user based on a data request log for the data resource within a preset time period (e.g., the past day, the past week, etc.), and create or update a suspicious user record. In response to receiving the data request transmitted by the data requester, the server 130 may obtain the suspicious user record that is previously stored. In some embodiments, the server 130 may obtain the suspicious user record from a storage module (not shown) in the processing device 132 or the data request processing apparatus 400. In some embodiments, the server 130 may obtain the suspicious user record from the storage device 140 via the network 120. The server 130 may then determine whether the data requester has the permission to acquire the data resource based on the suspicious user record. In some embodiments, in response to receiving the data request transmitted by the data requester, the server 130 may obtain the data request log for the data resource within the preset time period. The server 130 may then directly determine whether the data requester has the permission to acquire the data resource based on the data request log. Detailed descriptions of the determination of whether the data requester has the permission to acquire the data resource may be found elsewhere in the present disclosure (e.g., FIG. 6 and/or FIG. 7 and the descriptions thereof). It should be understood that the server 130 may also determine whether the data requestor has the permission to acquire the data resource by other means, and the present disclosure is not intended to be limiting in this aspect.

In step 506, the server 130 (e.g., the processing device 132, the data request processing apparatus 400, the prohibiting module 406, the processor 210, and/or the processing circuits 210-2) may prohibit the server 130 to respond to the data request, if the data requester has no permission to acquire the data resource. If the data requester has no permission to acquire the data resource, the server 130 may be prohibited to respond to the data request, and may not return the data resource to the data requester. In some embodiments, if the data requester has the permission to acquire the data resource, the server 130 may further respond to the data request. The server 130 may obtain the data resource, and transmit the data resource to the data requester. In some embodiments, the server 130 may obtain the data resource from a storage module in the processing device 132 or the data request processing apparatus 400. In some embodiments, the server 130 may obtain the data resource from the storage device 140 or an external storage device via the network 120.

The process 500 for processing data requests provided by the above embodiments of the present disclosure may determine whether the data requester has the permission to acquire the data resource by receiving the data request transmitted by the data requester. The data request may be used to request to acquire the data resource. If the data requester has no permission to acquire the data resource, the process 500 may prohibit the server 130 to respond to the data request. Therefore, the process 500 may prevent a malicious user from posing as a normal user to frequently transmit data requests (e.g., frequently transmit data requests through the web crawler technology) to acquire the data resource and thus, improving the security of the data resource.

It should be noted that the above description is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure.

FIG. 6 is a flowchart illustrating an exemplary process 600 for processing data requests according to some embodiments of the present disclosure. The process 600 describes the determination of whether a data requester has a permission to acquire a data resource in detail. In some embodiments, step 504 of the process 500 in FIG. 5 may be implemented by performing one or more steps of the process 600. In some embodiments, the process 600 may be implemented in the system 100 illustrated in FIG. 1. For example, the process 600 may be implemented on the server 130 (or the processing device 132 of the server 130). As another example, the process 600 may be implemented on the data request processing apparatus 400. As another example, the process 600 may be stored in the storage device 140 and/or the storage 220 as a form of instructions (e.g., an application), and invoked and/or executed by the server 130 (e.g., the processing device 132 of the server 130, the processor 220 illustrated in FIG. 2, or one or more modules and/or units in the data request processing apparatus 400 illustrated in FIG. 4). The operations of the illustrated process presented below are intended to be illustrative. In some embodiments, the process 600 may be accomplished with one or more additional operations not described, and/or without one or more of the operations discussed. Additionally, the order in which the operations of the process 600 as illustrated in FIG. 5 and described below is not intended to be limiting.

In step 602, the server 130 (e.g., the processing device 132, the data request processing apparatus 400, the receiving module 402, the processor 210, and/or the interface circuits 210-1) may receive a data request transmitted by a data requester. The data request may be used to request to acquire a data resource. Step 602 may be similar to step 502 of FIG. 5, and therefore the descriptions thereof are not repeated here.

In step 604, the server 130 (e.g., the processing device 132, the data request processing apparatus 400, the first determination module 404, the obtaining unit of the first determination module 404, the processor 210, and/or the interface circuits 210-1) may obtain a suspicious user record that is previously stored. In some embodiments, the suspicious user record may be previously stored in a storage module (not shown) in the processing device 132 or the data request processing apparatus 400. The server 130 may obtain the suspicious user record from the storage module. In some embodiments, the suspicious user record may be previously stored in the storage device 140. The server 130 may obtain the suspicious user record from the storage device 140 via the network 120.

In some embodiments, the suspicious user record may include one or more user identifiers of one or more suspicious users. A user identifier may include an identification (ID), a communication number (e.g., a telephone number, a Wechat™ number), etc. In some embodiments, the suspicious user record may also include one or more occurrence times of suspicious events corresponding to a user identifier. It should be understood that the suspicious user record may also include other information. The present disclosure is not intended to be limiting in the specific content recorded in the suspicious user record. In some embodiments, the suspicious user record may record the one or more user identifiers and the corresponding one or more occurrence times of suspicious events in the form of, for example, a table. In the present disclosure, a suspicious user may be a malicious user that intends to acquire the data resource for malicious purposes, e.g., for copying data of the server 130. For example, the suspicious user may frequently transmit data requests (e.g., frequently transmit the data requests through the web crawler technology) to request to acquire the data resource of the server 130. The suspicious event corresponding to the user identifier of the suspicious user may refer to operations of the suspicious user. The suspicious event may include operations associated with acquiring the data resource of the server 130, for example, an operation of transmitting a data request to request the data resource of the server 130. Detailed descriptions of the suspicious user and the suspicious event may be found elsewhere in the present disclosure (e.g., FIG. 7 and the descriptions thereof).

In step 606, the server 130 (e.g., the processing device 132, the data request processing apparatus 400, the first determination module 404, the determination unit of the first determination module 404, the processor 210, and/or the interface circuits 210-1) may determine whether the data requester has a permission to acquire the data resource based on the suspicious user record.

In some embodiments, the data request transmitted by the data requester may include the user identifier (e.g., the ID, the communication number, etc.) of the data requester. The server 130 may search for the user identifier of the data requester in the suspicious user record. If the user identifier of the data requester is not recorded in the suspicious user record, the server 130 may determine that the data requester has the permission to acquire the data resource. In some embodiments, if the user identifier of the data requester is recorded in the suspicious user record, the server 130 may determine that the data requester has no permission to acquire the data resource.

In some embodiments, if the user identifier of the data requester is recorded in the suspicious user record, the server 130 may further obtain an occurrence time of a suspicious event corresponding to the user identifier of the data requester from the suspicious user record. The server 130 may determine whether the data requester has the permission to acquire the data resource based on the occurrence time of the suspicious event.

Specifically, in some embodiments, the server 130 may determine whether the data requester has the permission to acquire the data resource based on the occurrence time of the suspicious event using the following method. Firstly, the server 130 may determine a current time (e.g., a current date, etc.). The server 130 may then determine a suspicious coefficient corresponding to the data requester based on the current time and the occurrence time of the suspicious event (e.g., the occurrence date of the suspicious event). If the suspicious coefficient is less than a preset value, the server 130 may determine that the data requester has the permission to acquire the data resource. If the suspicious coefficient is greater than or equal to the preset value, the server 130 may determine that the data requestor has no permission to acquire the data resource. In some embodiments, the preset value may be default settings of the system 100, or may be adjusted under different situations. Merely by way of example, the preset value may be 0.1, 0.2, 0.3, 0.4, 0.5, etc.

In some embodiments, the suspicious coefficient corresponding to the data requester may be negatively correlated with a target time interval. The target time interval may be a time interval between the current time and the occurrence time of the suspicious event corresponding to the user identifier of the data requester (e.g., the interval between the current date and the occurrence date of suspicious event corresponding to the user identifier of the data requester). For example, the server 130 may determine the suspicious coefficient by the following equation:

$$D = {\sum }_{{T}_{i} ∈ Time ( P )} {2}^{- λ ( {t}_{c} - {T}_{i} )}$$

wherein D represents the suspicious coefficient corresponding to the data requester, Tᵢ represents the occurrence time (e.g., the occurrence date) of the i^{th} suspicious event corresponding to the user identifier of the data requester, Time(P) represents a set of occurrence times of the suspicious events corresponding to the user identifier of the data requester, t_{c} represents the current time, and A represents a preset threshold. In some embodiments, the preset threshold A may be set as 0.28.

It should be understood that the server 130 may also determine the suspicious coefficient by any other reasonable equations, and the present disclosure is not intended to be limiting in the specific method of determining the suspicious coefficient.

In step 608, the server 130 (e.g., the processing device 132, the data request processing apparatus 400, the prohibiting module 406, the processor 210, and/or the processing circuits 210-2) may prohibit the server 130 to respond to the data request, if the data requester has no permission to acquire the data resource. Step 608 may be similar to step 506 of FIG. 5, and therefore the descriptions thereof is not repeated here.

The process 600 for processing the data requests provided by the above embodiments of the present disclosure may determine whether the data requester has the permission to acquire the data resource by receiving the data request transmitted by the data requester, obtaining the suspicious user record that is previously stored, and determining whether the data requester has the permission to acquire the data resource based on the suspicious user record. The data request may be used to request to acquire the data resource. If the data requester has no permission to acquire the data resource, the process 600 may prohibit the server 130 to respond to the data request. Therefore, the process 600 may prevent a malicious user from posing as a normal user to frequently transmit data requests (e.g., frequently transmit data requests through the web crawler technology) to acquire the data resource and thus, improving the security of the data resource.

It should be noted that the above description is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure.

FIG. 7 is a flowchart illustrating an exemplary process 700 for processing data requests according to some embodiments of the present disclosure. The process 700 describes the process of creating or updating a suspicious user record in detail. The process 700 may be implemented in the system 100 illustrated in FIG. 1. For example, the process 700 may be implemented on the server 130 (or the processing device 132 of the server 130). As another example, the process 700 may be implemented on the data request processing apparatus 400. As yet another example, the process 700 may be stored in the storage device 140 and/or the storage 220 as a form of instructions (e.g., an application), and invoked and/or executed by the server 130 (e.g., the processing deice 132 of the server 130, the processor 220 illustrated in FIG. 2, or one or more modules and/or units in the data request processing apparatus 400 illustrated in FIG. 4). The operations of the illustrated process presented below are intended to be illustrative. In some embodiments, the process 700 may be accomplished with one or more additional operations not described, and/or without one or more of the operations discussed. Additionally, the order in which the operations of the process 700 as illustrated in FIG. 5 and described below is not intended to be limiting.

In step 702, the server 130 (e.g., the processing device 132, the data request processing apparatus 400, the obtaining module of the data request processing apparatus 400, the processor 210, and/or the interface circuits 210-1) may obtain a data request log for a data resource within a preset time period. The data resource may be stored in the server 130 (e.g., a storage module of the processing device 132 or the data request processing apparatus 400), or in a storage device in communication with the server 130 (e.g., the storage device 140). The data resource may be any form of data resource. For example, taking the 020 service of the vehicle as an example, the data resource may be a map data resource, including but not limited to a data resource of building entrances and exits, a data resource of pick-up points recommendation, a data resource of nearby shops recommendation, etc. In some embodiments, the data resource may include data in any form, such as text data, image data, audio data, video data, etc. The data request log for the data resource may be a log that records information of requesting to acquire the data resource. In some embodiments, the data request log may record user identifiers (e.g., IDs, communication numbers) of users that request to acquire the data resource, the number of data requests generated by the users, time information of the users requesting to acquire the data resource (e.g., the time when the data requests are generated by the users), and/or the location information corresponding to the data resource requested by the users, etc.

The preset time period may be any reasonable time period. In some embodiments, the preset time period may be default settings of the system 100, or may be adjusted under different situations. For example, the preset time period may be the past day, the past two days, the past week, the past month, the past two months, etc. The present disclosure is not intended to be limiting in the specific setting of the preset time period. In some embodiments, the server 130 may obtain the data request log for the data resource within the preset time period from a storage module (not shown) in the processing device 132 or the data request processing apparatus 400. In some embodiments, the server 130 may obtain the data request log for the data resource within the preset time period from the storage device 140 via the network 120. In some embodiments, the server 130 may obtain the data request log for the data resource within the preset time period at regular intervals (e.g., every other day, every two days, every other week, etc.).

In step 704, the server 130 (e.g., the processing device 132, the data request processing apparatus 400, the second determination module of the data request processing apparatus 400, the processor 210, and/or the processing circuits 210-2) may determine a suspicious user within the preset time period based on the data request log. In some embodiments, the suspicious user may be a malicious user that intends to acquire the data resource for malicious purposes, e.g., for copying data of the server 130. For example, the suspicious user may frequently transmit data requests (e.g., frequently transmit the data requests through the web crawler technology) to request to acquire the data resource of the server 130.

In some embodiments, the server 130 may determine a user in the data request log, whose number of requests being greater than or equal to a preset number of times, as the suspicious user within the preset time period. The server 130 may determine a user in the data request log, whose number of requests being less than the preset number of times, as a normal user. As used herein, the term “number of requests” may refer to the number of data requests generated by a user. In some embodiments, the preset number of times may be default settings of the system 100, or may be adjusted under different situations. Merely by way of example, the preset number of times may be 5, 10, 15, etc.

In some embodiments, the server 130 may determine a user in the data request log, whose number of requests being greater than or equal to the preset number of times, as the suspicious user within the preset time period. The server 130 may determine a user in the data request log, whose number of requests being less than the preset number of times, as a candidate user. The server 130 may further determine whether the candidate user is the suspicious user or the normal user. In some embodiments, the server 130 may obtain the number of time period distributions corresponding to data requests generated by candidate users based on the data request log. The number of data requests generated by each of the candidate users may be less than the preset number of times. For example, one hour may be determined as one time period, and one day may be divided into twenty-four time periods. If the data requests generated by candidate user A occur at the time periods corresponding to 7:00, 8:00, 9:00, 11:00, and 13:00, the number of time period distributions corresponding to data requests generated by the candidate A may be five. The server 130 may determine a candidate user, whose number of time period distributions being greater than a first threshold, as the suspicious user within the preset time period. The server 130 may determine a candidate user, whose number of time period distributions being less than the first threshold, as the normal user. In some embodiments, the first threshold may be default settings of the system 100, or may be adjusted under different situations. Merely by way of example, the first threshold may be 5, 10, 15, etc.

In some embodiments, the server 130 may determine the user in the data request log, whose number of requests being greater than or equal to the preset number of times, as the suspicious user within the preset time period. The server 130 may determine a user in the data request log, whose number of requests being less than the preset number of times, as a candidate user. The server 130 may further determine whether the candidate user is the suspicious user or the normal user. In some embodiments, the server 130 may obtain the number of city distributions corresponding to data requests generated by candidate users based on the data request log. The number of data requests generated by each of the candidate users may be less than the preset number of times. For example, if the data requests generated by candidate user B request the data resources located at five cities of Beijing, Shanghai, Shenzhen, Chengdu, and Hangzhou, respectively, the number of city distributions corresponding to data requests generated by the candidate B may be five. The server 130 may determine a candidate user, whose number of city distributions being greater than a second threshold, as the suspicious user within the preset time period. The server 130 may determine a candidate user, whose number of city distributions being less than the second threshold, as the normal user. In some embodiments, the second threshold may be default settings of the system 100, or may be adjusted under different situations. Merely by way of example, the second threshold may be 5, 10, 15, etc.

It should be understood that the server 130 may also determine the suspicious user within the preset time period by any other reasonable manner. The present disclosure is not intended to be limiting in the specific manner of determining the suspicious user within the preset time period.

In step 706, the server 130 (e.g., the processing device 132, the data request processing apparatus 400, the storage module of the data request processing apparatus 400, the processor 210, and/or the processing circuits 210-2) may create or update a suspicious user record based on the suspicious user within the preset time period.

In some embodiments, if it is the first time to determine the suspicious user within the preset time period, the server 130 may create and store the suspicious user record. In some embodiments, the server 130 may store the suspicious user record in a storage module of the processing device 132 or the data requests processing apparatus 400. In some embodiments, the server 130 may store the suspicious user record in the storage device 140. If it is not the first time (e.g., the second time, the third time) to determine the suspicious user within the preset time period, the server 130 may update the suspicious user record that has been stored. In some embodiments, the suspicious user record may record/include one or more user identifiers (e.g., IDs, communication numbers) of one or more suspicious users, the occurrence times (e.g., the occurrence dates) of suspicious events corresponding to the one or more user identifiers, etc. In some embodiments, the suspicious user record may record the one or more user identifiers and the corresponding one or more occurrence times of suspicious events in the form of, for example, a table.

In some embodiments, when updating the suspicious user record that has been stored, if the user identifier of a suspicious user that is newly determined has not been recorded in the suspicious user record, the server 130 may record the user identifier of the suspicious user and associate the occurrence time (e.g., occurrence date) of the suspicious event with the user identifier of the suspicious user in the suspicious user record. If the user identifier of a suspicious user that is newly determined has already been recorded in the suspicious user record, then the server 130 may record the occurrence time (e.g., the occurrence date) of the new suspicious event corresponding to the user identifier of the suspicious user in the suspicious user record.

In step 708, the server 130 (e.g., the processing device 132, the data request processing apparatus 400, the receiving module 402, the processor 210, and/or the interface circuits 210-1) may receive a data request transmitted by a data requester. The data request may be used to request to acquire the data resource. Step 708 may be similar to step 602 of FIG. 6 or step 502 of FIG. 5, and therefore the more descriptions thereof are not repeated here.

In step 710, the server 130 (e.g., the processing device 132, the data request processing apparatus 400, the first determination module 404, the obtaining unit of the first determination unit 404, the processor 210, and/or the interface circuits 210-1) may obtain the suspicious user record that is previously stored. The server 130 may obtain the suspicious user record that is created or updated in step 706. In some embodiments, the 130 may obtain the suspicious user record from a storage module of the processing device 132 or the data requests processing apparatus 400. In some embodiments, the server 130 may obtain the suspicious user record from the storage device 140. Step 710 may be similar to step 604 of FIG. 6, and therefore the more descriptions thereof are not repeated here.

In step 712, the server 130 (e.g., the processing device 132, the data request processing apparatus 400, the first determination module 404, the determination unit of the first determination unit 404, the processor 210, and/or the processing circuits 210-2) may determine whether the data requester has a permission to acquire the data resource based on the suspicious user record. Step 712 may be similar to step 606 of FIG. 6 or step 504 of FIG. 5, and therefore the more descriptions thereof are not repeated here.

In step 714, the server 130 (e.g., the processing device 132, the data request processing apparatus 400, the prohibiting module 406, the processor 210, and/or the processing circuits 210-2) may prohibit the server 130 to respond to the data request, if the data requester has no permission to acquire the data resource. Step 714 may be similar to step 608 of FIG. 6 or step 506 of FIG. 5, and therefore the more descriptions thereof are not repeated here.

The process 700 for processing the data requests provided by the above embodiments of the present disclosure may obtain the data request log for the data resource within the preset time period, determine the suspicious user within the preset time period based on the data request log, and create or update the suspicious user record based on the suspicious user within the preset time period. The process 700 may receive the data request transmitted by the data requester, the data request being used to request to acquire the data resource, obtain the suspicious user record that is previously stored, and determine whether the data requester has the permission to acquire the data resource based on the suspicious user record. If the data requester has no permission to acquire the data resource, the process 700 may prohibit the server 130 to respond to the data request. Therefore, a suspicious user may be filtered more accurately, and the process 700 may prevent a malicious user from posing as a normal user to frequently transmit data requests (e.g., frequently transmit data requests through the web crawler technology) to acquire the data resource and thus, improving the security of the data resource.

It should be noted that the above description is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. For example, the process 700 may include a storing step for storing the data request log, the suspicious user, and/or the suspicious user record during the processing of the data request.

As described above, the embodiments provided in FIGS. 4-7 may protect the data resource of the server 130 by prohibiting the server 130 to respond to the data request transmitted by the suspicious user (or the malicious user). In some embodiments, the prohibiting of responding to the data requests transmitted by the suspicious user (or the malicious user) may not prevent the behavior of the suspicious user for the data resource of the server 130. For example, the suspicious user (or the malicious user) may keep transmitting data requests to the server 130 until the server 130 returns data to the suspicious user. Under this situation, the server 130 may need to adopt other methods to and protect the data resource of the server 130.

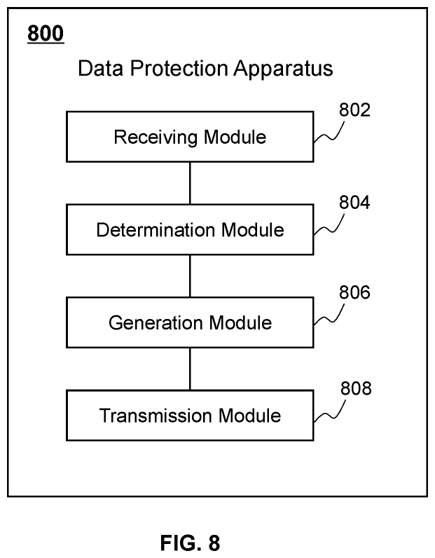

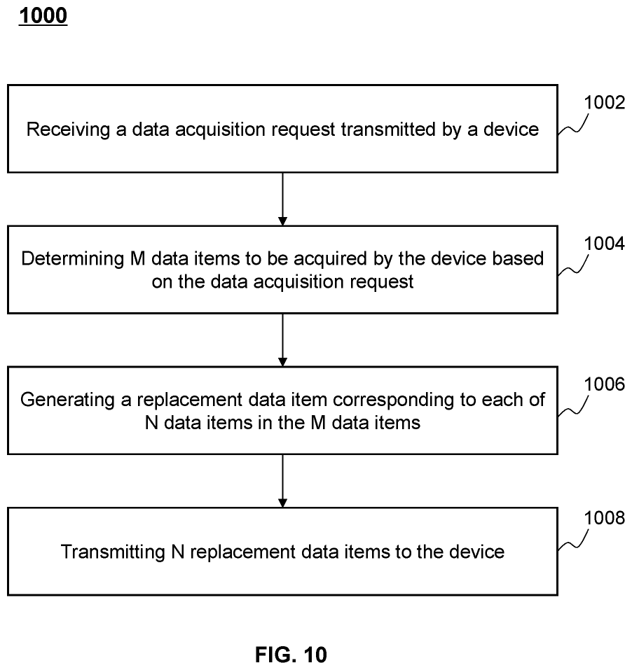

FIG. 8 is a block diagram illustrating an exemplary data protection apparatus 800 according to some embodiments of the present disclosure. In some embodiments, the data protection apparatus 800 may be an anti-crawler apparatus. In some embodiments, the data protection apparatus 800 may be part of the server 130. In some embodiments, the data protection apparatus 800 may be another server that is independent of the server 130. In some embodiments, the data protection apparatus 800 may be an implementation of the processing device 132. In some embodiments, the data protection apparatus 800 may be used to perform the process for data protection illustrated in FIGS. 10 and/or 11. In some embodiments, the data protection apparatus 800 may be implemented on the computing device 200 illustrated in FIG. 2, via its hardware, software, or a combination thereof. As shown in FIG. 8, the data protection apparatus 800 may include a receiving module 802, a determination module 804, a generation module 806, and a transmission module 808.

The receiving module 802 may be used to receive a data acquisition request transmitted by a device. The data acquisition request may be used to request to acquire data of the server 130. The data acquisition request may include information indicating the data to be acquired by the device. For example, the data acquisition request may include information indicating the amount of the data, the specific contents of the data, etc. In some embodiments, the data acquisition request may include a device identifier of the device. The device identifier of the device may include an IP address of the device, a device number of the device, etc. In some embodiments, the data to be acquired by the device may include open and available information in the web pages of the server 130, such as news data, map data, shopping information, etc. In some embodiments, the data may include text data, video data, audio data, image data, etc. In some embodiments, the device may be the terminal device 110 illustrated in FIG. 1. For example, the terminal device 110 may transmit the data acquisition request to the receiving module 802 via the network 120.

The determining module 804 may be used to determine M data items to be acquired by the device based on the data acquisition request. M is a positive integer. In some embodiments, the determination module 804 may also be used to determine a weight value of each of the M data items based on the number of times that each of the M data items is accessed. The determination module 804 may further determine M-N data item(s) based on the weight values. In some embodiments, the determination module 804 may also be used to determine whether the device identifier of the device is in a preset blacklist.

The generation module 806 may be used to generate a replacement data item corresponding to each of N data items in the M data items. N is a positive integer, and N is less than or equal to M.

The transmission module 808 may be used to transmit N replacement data items to the device. In some embodiments, if N is less than M, the transmission module 808 may also be used to transmit the M-N data item(s) to the device.

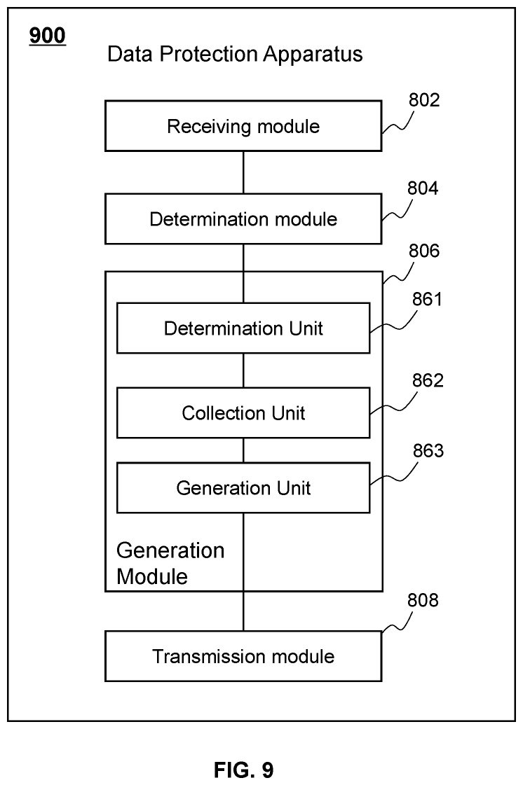

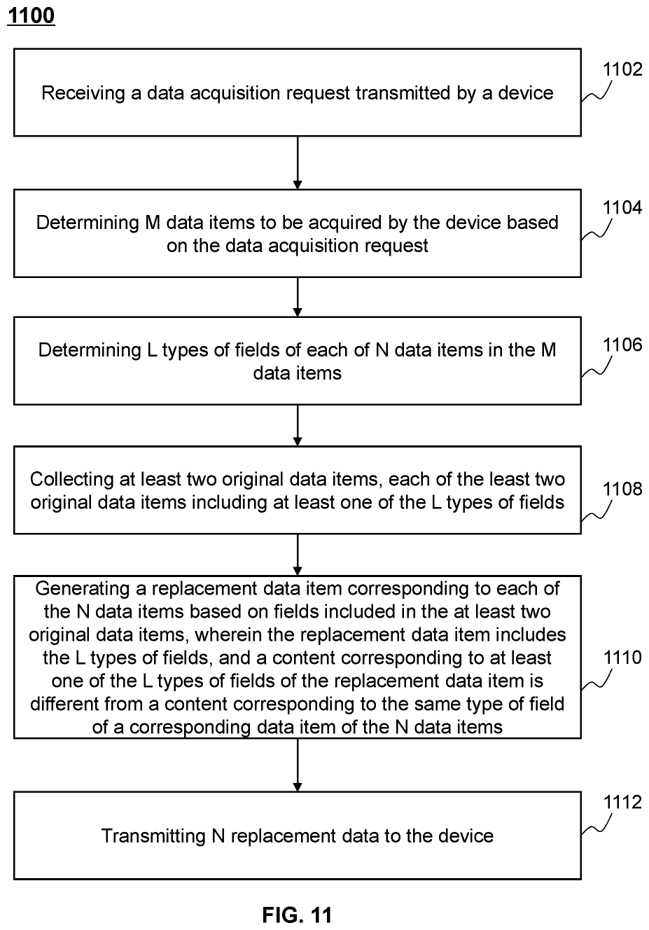

Detailed descriptions of the receiving module 802, the determination module 804, the generation module 806, and the transmission module 808 may be found elsewhere in the present disclosure (e.g., FIGS. 9-11 and the descriptions thereof). The data protection apparatus 800 provided by the embodiments of the present disclosure may perform the process illustrated in FIG. 10 and/or or FIG. 11 below.

The modules and/or units in the data protection apparatus 800 may be connected to or communicate with each other via a wired connection or a wireless connection. The wired connection may include a metal cable, an optical cable, a hybrid cable, or the like, or any combination thereof. The wireless connection may include a Local Area Network (LAN), a Wide Area Network (WAN), a Bluetooth™, a ZigBee™, a Near Field Communication (NFC), or the like, or any combination thereof. Two or more of the modules may be combined as a single module, and any one of the modules may be divided into two or more units. For example, the receiving module 802 may be integrated with the transmission module 808 as a single module which may receive the data acquisition request transmitted by the device and transmit the N replacement data items to the device.

It should be noted that the above description is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. For example, the data protection apparatus 800 may further include a storage module (not shown in FIG. 8). The storage module may be configured to store data generated during any process performed by any component of in the data protection apparatus 800. As another example, each of components of the data protection apparatus 800 may include a storage device. Additionally or alternatively, the components of the data protection apparatus 800 may share a common storage device.

FIG. 9 is block diagram illustrating an exemplary data protection apparatus 900 according to some embodiments of the present disclosure. In some embodiments, the data protection apparatus 900 may be a data anti-crawling apparatus. In some embodiments, the data protection apparatus 900 may be part of the server 130. In some embodiments, the data protection apparatus 900 may be another server that is independent of the server 130. In some embodiments, the data protection apparatus 900 may be an implementation of the processing device 132. In some embodiments, the data protection apparatus 900 may be integrated with the data protection apparatus as a single apparatus. In some embodiments, the data protection apparatus 900 may be used to perform the process for data protection illustrated in FIGS. 10 and/or 11. In some embodiments, the data protection apparatus 900 may be implemented on the computing device 200 illustrated in FIG. 2, via its hardware, software, or a combination thereof. As shown in FIG. 9, the data protection apparatus 900 may include the receiving module 802, the determination module 804, the generation module 806, and the transmission module 808 illustrated in FIG. 8. The generation module 806 may further include a determination unit 861, a collection unit 862, and a generation unit 863.

The determination unit 861 may be used to determine L types of fields of each of N data items in the M data items. L is a positive integer. Each of the N data item in the M data items may include the L types of fields. In some embodiments, the determination unit 861 may determine the L types of fields of each of the N data items based on the M data items.

The collection unit 862 may be used to collect at least two original data items. For each of the N data items, the collection unit 862 may collect at least two original data items. The collection unit 862 may collect the at least two original data items based on the L types of fields of each of the N data items. Each of the at least two original data items may include at least one of the L types of fields. The types of fields included in the at least two original data items may piece together the L types of fields of each of the N data items.

The generation unit 863 may be used to generate a replacement data item corresponding to each of the N data items based on fields included in the at least two original data items. The replacement data item may be false data of a corresponding data item of the N data items. The replacement data item may include the L types of fields. A content corresponding to at least one of the L types of fields of the replacement data item may be different from a content corresponding to the same type of field of a corresponding data item of the N data items. In some embodiments, the generation unit 863 may select the L types of fields from the fields included in the at least two original data items. The generation unit 863 may then generate the replacement data item by combining contents corresponding to the L types of fields in the at least two original data items, respectively.

Detailed descriptions of the generation module 806 may be found elsewhere in the present disclosure (e.g., FIG. 11 and the descriptions thereof).

FIG. 10 is a flowchart illustrating an exemplary process 1000 for data protection according to some embodiments of the present disclosure. In some embodiments, the process 1000 may be implemented in the system 100 illustrated in FIG. 1. For example, the process 1000 may be implemented on the server 130 (or the processing device 132 of the server 130). As another example, the process 1000 may be implemented on the data protection apparatus 800 or the data protection apparatus 900. As yet another example, the process 1000 may be stored in the storage device 140 and/or the storage 220 as a form of instructions (e.g., an application), and invoked and/or executed by the server 130 (e.g., the processing device 132 of the server 130, the processor 220 illustrated in FIG. 2, one or more modules and/or units in the data protection apparatus 800 illustrated in FIG. 8, or one or more modules and/or units in the data protection apparatus 900 illustrated in FIG. 9). The operations of the illustrated process presented below are intended to be illustrative. In some embodiments, the process 1000 may be accomplished with one or more additional operations not described, and/or without one or more of the operations discussed. Additionally, the order in which the operations of the process 1000 as illustrated in FIG. 10 and described below is not intended to be limiting.

In step 1002, the server 130 (e.g., the processing device 132, the data protection apparatus 800, the data protection apparatus 900, the receiving module 802, the processor 210, and/or the interface circuits 210-1) may receive a data acquisition request transmitted by a device. The data acquisition request may be used to request to acquire data of the server 130. In some embodiments, the data acquisition request may include information indicating the data to be acquired by the device. For example, the data acquisition request may include information indicating the amount of the data to be acquired by the device, the specific contents of the data to be acquired by the device, etc. In some embodiments, the data acquisition request may include a device identifier of the device. The device identifier of the device may include an internet protocol (IP) address of the device, a device number of the device, etc. In some embodiments, the data to be acquired by the device may include open and available information in the web pages of the server 130, such as news data, map data, shopping information, etc. In some embodiments, the data may include any form of data, such as text data, video data, audio data, image data, etc.

In some embodiments, the device may be the terminal device 110 illustrated in FIG. 1. For example, the terminal device 110 may transmit the data acquisition request to the server 130 via the network 120. In some embodiments, the data acquisition request may be transmitted by a user of the device. For example, the user may transmit the data acquisition request to the server 130 through the device (e.g., a user interface of the device). In some embodiments, the data acquisition request may be transmitted by a normal user and used to acquire the data of the server 130 normally. The data acquisition request transmitted by the normal user may be referred to as a normal request. In some embodiments, the data acquisition request may be transmitted by an abnormal user (or a malicious user) and used to acquire the data of the server 130 for malicious purposes, e.g., for copying data of the server 130. For example, the abnormal user may be a user that competes with the owner of the data of the server 130, and transmit the data acquisition request for copying the data of the server 130. The abnormal user may also be referred to as a data acquirer. The data acquisition request transmitted by the data acquirer may be referred to as an abnormal request.

When the data acquirer wants to acquire the data of the server 130, the data acquirer may transmit data acquisition requests (abnormal requests) to the server 130 through the device. In some embodiments, the data acquirer may transmit the data acquisition requests using the web crawler technology. For example, the data acquirer may transmit the data acquisition requests to the server 130 through a web crawler application installed on the device. The web crawler application may be used to transmit the data acquisition requests to the server 130 to acquire data automatically and repeatedly.

In step 1004, the server 130 (e.g., the processing device 132, the data protection apparatus 800, the data protection apparatus 900, the determination module 804, the processor 210, and/or the processing circuits 210-2) may determine M data items to be acquired by the device based on the data acquisition request. M is a positive integer. As described in connection with step 1002, the data acquisition request may include information indicating the data to be acquired by the device. Therefore, the server 130 may determine M data items to be acquired by the device based on the data acquisition request. A data item may be a part of the data to be acquired by the device, and the M data items may form the data to be acquired by the device. In the present disclosure, a data item may be real data of the server 130. The M data items to be acquired by the device may be real data of the server 130. In some embodiments, the real data of the server 130 may be stored in the server 130 (e.g., a storage module in the processing device 132, the data protection apparatus 800 or the data protection apparatus 900) or in a storage device in communication with the server 130 (e.g., the storage device 140).

In some embodiments, before the determination of the M data items to be acquired by the device based on the data acquisition request, the server 130 may determine the sender of the data acquisition request. The server 130 may determine whether the data acquisition request is a normal request transmitted by a normal user, or an abnormal request transmitted by a data acquirer. In some embodiments, the server 130 may determine whether the data acquisition request is a normal request or an abnormal request based on the device identifier (e.g., the IP address, the device number) of the device included in the data acquisition request. For example, the server 130 may determine whether the device identifier of the device is in a preset blacklist. The preset blacklist may include a plurality of device identifiers corresponding to a plurality of devices that have been identified in advance. If the device identifier of the device is in the preset blacklist, the server 130 may determine that the data acquisition request is an abnormal request that is transmitted by a data acquirer through the device. If the device identifier of the device is not in the preset blacklist, the server 130 may determine that the data acquisition request is a normal request that is transmitted by a normal user through the device.

In step 1006, the server 130 (e.g., the processing device 132, the data protection apparatus 800, the data protection apparatus 900, the generation module 806, the processor 210, and/or the processing circuits 210-2) may generate a replacement data item corresponding to each of N data items in the M data items. N is less than or equal to M, and M and N are positive integers. In some embodiments, when the server 130 determines that the data acquisition request is an abnormal request transmitted by a data acquirer, the server 130 may directly mask the data acquisition request of the data acquirer (or prohibit the server 130 to respond to the data acquisition request of the data acquirer), for example, the server 130 may not respond to the data acquisition request of the data acquirer. However, in some cases, the direct masking of the data acquisition request of the data acquirer may not effectively crack down the behavior of the data acquirer for the data of the server 130, and may cause the data acquirer to change the strategy and continue to acquire the data of the server 130. Therefore, when the server 130 determines that the data acquisition request is an abnormal request transmitted by the data acquirer, the server 130 may generate the replacement data item corresponding to each of the N data items in the M data items. In the present disclosure, a replacement data item may be false data corresponding to a data item of the N data items.

In some embodiments, if N is equal to M, the server 130 may generate the replacement data item corresponding to each of all the M (or N) data items. Accordingly, the server 130 may generate and transmit M (or N) replacement data items (i.e., false data) to the device. In some embodiments, if N is less than M, the server 130 may generate the replacement data item corresponding to each of the N data items in the M data items. Accordingly, the server 130 may generate and transmit N replacement data items (i.e., false data) to the device. The server 130 may also transmit M-N data item(s) (i.e., real data) to the device and thus, increasing the difficulty of data identification for the data acquirer. Detailed descriptions of the generation of the replacement data item may be found elsewhere in the present disclosure (e.g., FIG. 11 and the descriptions thereof).

In step 1008, the server 130 (e.g., the processing device 132, the data protection apparatus 800, the data protection apparatus 900, the transmission module 808, the processor 210, and/or the interface circuits 210-1) may transmit N replacement data items to the device. The server 130 may generate the N replacement data items (i.e., false data) corresponding to the N data items (i.e., real data) in the M data items, respectively. The server 130 may then transmit the N replacement data items to the device. The data acquirer may acquire the N replacement data items through the device. If N is equal to M, the server 130 may generate and transmit the M (or N) replacement data items to the device. If N is less than M, the server 130 may generate N and transmit the N replacement data items to the device. In some embodiments, the server 130 may also transmit M-N data item(s) (i.e., real data) to the device.

In some embodiments, the server 130 may directly transmit the N replacement data items (and/or the M-N data item(s)) to the device. For example, the server 130 may directly transmit the N replacement data items (and/or the M-N data item(s)) to the terminal device 110 via, for example, the network 120. In some embodiments, the server 130 may carry the N replacement data items (and/or the M-N data item(s)) in a data acquisition response and transmit the data acquisition response to the device. The device may then acquire the N replacement data items (and/or the M-N data items) in the received data acquisition response.

The process 1000 for data protection provided by the embodiments of the present disclosure may determine the M data items to be acquired by the device based on the data acquisition request after receiving the data acquisition request transmitted by the device. The process 1000 may also determine the sender of the data acquisition request before the determination of the M data items to be acquired by the device. If the data acquisition request is an abnormal request transmitted by a data acquirer, the process 1000 may generate the replacement data item corresponding to each of the N data items in the M data items, and transmit the N replacement data items (i.e., false data) to the device. If N is less than M, the process 1000 may also transmit M-N data item(s) to the device. Therefore, the process 1000 may mislead the data acquirer and make the data acquirer fail to identify or need to spend a large cost to identify real or false of the data received by the data acquirer, and thus improving the effect of data protection.

FIG. 11 is a flowchart illustrating an exemplary process 1100 for data protection according to some embodiments of the present disclosure. FIG. 11 illustrates the embodiments of how to generate the replacement data items corresponding to each of the N data items in the M data items in detail based on the embodiments shown in FIG. 10. In some embodiments, step 1006 of FIG. 10 may be implemented by performing one or more operations in process 1100. The process 1100 may be implemented in the system 100 illustrated in FIG. 1. For example, the process 1100 may be implemented on the server 130 (or the processing device 132 of the server 130). As another example, the process 1100 may be implemented on the data protection apparatus 800 or the data protection apparatus 900. As yet another example, the process 1100 may be stored in the storage device 140 and/or the storage 220 as a form of instructions (e.g., an application), and invoked and/or executed by the server 130 (e.g., the processing device 132 of the server 130, the processor 220 illustrated in FIG. 2, one or more modules and/or units in the data protection apparatus 800 illustrated in FIG. 8, or one or more modules and/or units in the data protection apparatus 900 illustrated in FIG. 9). The operations of the illustrated process presented below are intended to be illustrative. In some embodiments, the process 1100 may be accomplished with one or more additional operations not described, and/or without one or more of the operations discussed. Additionally, the order in which the operations of the process 1100 as illustrated in FIG. 10 and described below is not intended to be limiting.

In step 1102, the server 130 (e.g., the processing device 132, the data protection apparatus 800, the data protection apparatus 900, the receiving module 802, the processor 210, and/or the interface circuits 210-1) may receive a data acquisition request transmitted by a device. The data acquisition request may be used to request to acquire data of the server 130. In some embodiments, the data acquisition request may be an abnormal request transmitted by a data acquirer through the device.

In step 1104, the server 130 (e.g., the processing device 132, the data protection apparatus 800, the data protection apparatus 900, the determination module 804, the processor 210, and/or the processing circuits 210-2) may determine M data items to be acquired by the device based on the data acquisition request. M is a positive integer.

Steps 1102 and 1104 may be similar to Steps 1002 and 1004, respectively, and therefore the descriptions thereof are not repeated here.

In step 1106, the server 130 (e.g., the processing device 132, the data protection apparatus 800, the data protection apparatus 900, the generation module 806, the determination unit 861, the processor 210, and/or the processing circuits 210-2) may determine L types of fields of each of N data items in the M data items. N is a positive integer, and N is less than or equal to M. L is a positive integer. A type of field (or a field) of a data item may be a part of the data item. The data item may include one or more types of fields (or fields). Merely by way of example, a data item may include “A” field, “B” field, “C” field, etc. The letters “A,” “B,” and/or “C” may be referred to as field names.

Each of the N data items in the M data items may include the L types of fields. In some embodiments, the server 130 may determine the L types of fields of each of the N data items based on the M data items. For example, if the M data items to be acquired by the device are map data (e.g., the map data of Tiananmen), the server 130 may determine that the map data may include six types of fields: “identification (ID)” field, “name” field, “address” field, “longitude” field, “latitude” field and “alias” field. Accordingly, the server 130 may determine the six types of fields as the L types of fields of each of the N data items.

In step 1108, the server 130 (e.g., the processing device 132, the data protection apparatus 800, the data protection apparatus 900, the generation module 806, the collection unit 862, the processor 210, and/or the processing circuits 210-2) may collect at least two original data items. For each of the N data items, the server 130 may collect at least two original data items. The server 130 may collect the at least two original data items based on the L types of fields of each of the N data items. Each of the at least two original data items may include at least one of the L types of fields. The types of fields included in the at least two original data items may piece together the L types of fields, i.e., the types of fields included in the at least two original data items may include the L types of fields.

In some embodiments, the server 130 may collect the at least two original data items randomly. In some embodiments, the types of fields included in the at least two original data items collected by the server 130 may be the same as the L types of fields. For example, the L types of fields may include three types of fields, e.g., “A” field, “B” field, and “C” field. Accordingly, the types of fields included in the at least two original data items collected by the server 130 may be the “A” field, the “B” field, and the “C” field. Furthermore, in some embodiments, one part of the at least two original data items may include one part of the L types of fields, and another part of the at least two original data items may include another part of the L types of fields. For example, the L types of fields may include the three types of fields, and the at least two original data items collected may include a first original data item and a second original data item. Merely by way of example, the first original data item may include the “A” field, and the second original data item may include the “B” field, and the “C” field. Alternatively, in some embodiments, each of the at least two original data items may include the L types of fields.

In some embodiments, the types of fields included in the at least two original data items collected by the server 130 may include the L types of fields and additional one or more other types of fields. Similarly, in some embodiments, one part of the at least two original data items may include one part of the L types of fields, and another part of the at least two original data items may include another part of the L types of fields. In some embodiments, each of the at least two original data items may include the L types of fields.

In some embodiments, for each of the N data items, the at least two original data items collected by the server 130 may be associated with a characteristic corresponding to the data item of the N data items. In some embodiments, the characteristic may include location information corresponding to the data item. For example, each of the N data items in the M data items may be map data. Each of the N data items may correspond to a location. For each of the N data items, the server 130 may collect map data corresponding to at least two locations within a preset distance (e.g., one kilometer, two kilometers) around the location corresponding to the data item. The server 130 may determine the map data corresponding to the at least two locations as the at least two original data items. Each of the at least two locations may correspond to one of the at least two original data items. In this case, each of the at least two original data items may include the L types of fields. Merely by way of example, each of the N data items may be the map data of Tiananmen. Each of the N data items may include six types of fields: “identification (ID)” field, “name” field, “address” field, “longitude” field, “latitude” field and “alias” field. For each of the N data items, the server 130 may collect map data corresponding to at least two locations within one kilometers around Tiananmen. The server 130 may determine the map data corresponding to the at least two locations within one kilometers around Tiananmen as the at least two original data items of the data item. Each of the at least two original data items may include the six types of fields.

In step 1110, the server 130 (e.g., the processing device 132, the data protection apparatus 800, the data protection apparatus 900, the generation module 806, the generation unit 863, the processor 210, and/or the processing circuits 210-2) may generate a replacement data item corresponding to each of the N data items based on fields included in the at least two original data items. The replacement data item may be false data corresponding to a data item of the N data items. The replacement data item may include the L types of fields. A content corresponding to at least one of the L types of fields of the replacement data item may be different from a content corresponding to the same type of field of a corresponding data item of the N data items. In some embodiments, the server 130 may select the L types of fields from the fields included in the at least two original data items. The server 130 may then generate the replacement data item by combining contents corresponding to the L types of fields in the at least two original data items, respectively.

In some embodiments, each of the at least two original data items may include the L types of fields. In some embodiments, during the generation of the replacement data item, the server 130 may select one part of the L types of fields from one part of the at least two original data items and select another part of the L types of fields from another part of the at least two original data items. For example, the at least two original data items may include a first original data item and a second original data item. Each of the first original data item and the second original data item includes the L types of fields. During the generation of the replacement data item, the server 130 may select one part of the L types of fields from the first original data item, and select another part of the L types of fields from the second original data item. The server 130 may then generate the replacement data item by combining the contents corresponding to the one part of the L types of fields in the first original data item and the contents corresponding to the another part of the L types of fields in the second original data item. Alternatively, in some embodiments, during the generation of the replacement data item, the server 130 may select the L types of fields from a part of the at least two original data items. For example, the at least two original data items may include a first original data item and a second original data item. Each of the first original data item and the second original data item includes the L types of fields. During the generation of the replacement data item, the server 130 may select the L types of fields from the first original data item (or the second original data item). The contents corresponding to the L types of fields of the replacement data item may be the contents corresponding to the L types of fields in the first original data item (or the second original data item). As another example, the at least two original data items may include a first original data item, a second original data item, and a third original data item. Each of the first original data item, the second original data item and the third original data item includes the L types of fields. During the generation of the replacement data item, the server 130 may select the L types of fields from the first original data item and the second original data item. The server 130 may select one part of the L types of fields from the first original data item and select another part of the L types of fields from the second original data item. The server 130 may then generate the generate the replacement data item by combining contents corresponding to the L types of fields in the first original data item and the second original data item, respectively. In some embodiments, L may be equal to one. Each of the N data items may include one type of field, and each of the at least two original data items may include the type of field. During the generation of the replacement data item, the server 130 may select the type of field from one of the at least two original data items randomly. The content corresponding to the type of field of the replacement data item may be the content corresponding to the type of filed in the selected original data item.

For example, the M data items may be map data, and each of the N data items in the M data items may include six types of field as illustrated in Table 1, i.e., “ID” field, “name” field, “address” field, “longitude” field, “latitude” field and “alias” field. For each of the N data items, the at least two original data items collected may include six original data items: original data item poi0, original data item poll, original data item poi2, original data item poi3, original data item poi4, and original data item poi5. Each of the six original data items may include the six types of fields illustrated in Table 1. During the generation of the replacement data item of the corresponding data item of the N data items, the server 130 may select the six types of fields from the fields included in the six original data items. The server 130 may then generate the replacement data item by combining contents corresponding to the six types of fields in the six original data items, respectively.

TABLE 1

| Field number | Field name |
|---|---|
| 0 | identification (ID) |
| 1 | name |
| 2 | address |
| 3 | longitude |
| 4 | latitude |
| 5 | alias |

In some embodiments, the server 130 may select each of the six types of fields from the fields included in one of the six original data items. The server 130 may select different types of fields from the fields included in the six original data items, respectively. In some embodiments, during the generation of the replacement data item, the server 130 may generate a random number ranging from 0 to 5 (corresponding to field number ranging from 0 to 5 illustrated in Table 1). The server 130 may also generate a data structure “poi_fake”, which represents the replacement data item. The server 130 may generate the replacement data item using a traversal algorithm. The traversal algorithm may include six iterations. In the first iteration, the random number may be set to 0, which corresponds to the “ID” field. The server 130 may select one of the six original data items, i.e., the original data item poi0, the original data item poll, the original data item poi2, the original data item poi3, the original data item poi4, or the original data item poi5. The server 130 may select the “ID” field from the fields included in the selected original data item. The content corresponding to the “ID” field of the replacement data item (i.e., the data structure “poi_fake”) may be the content corresponding to the “ID” field of the selected original data item. In the second iteration, the random number may be increased to 1, which corresponds to the “name” field. The server 130 may select one of the six original data items that is different from the one selected in the first iteration. The server 130 may select the “name” field from the fields included in the selected original data item in the second iteration. The content corresponding to the “name” field of the replacement data item (i.e., the data structure “poi_fake”) may be the content corresponding to the “name” field of the selected original data item in the second iteration. The server 130 may generate the replacement data item (i.e., the data structure “poi_fake”) by performing the six iterations. In the six iterations, the random number may range from 0 to 5, which corresponds to the “ID” field, “name” field, “address” field, “longitude” field, “latitude” field and “alias” field, respectively. The server 130 may select different types of fields from the six types of fields included in each of the six original data items. Merely by way of example, using the traversal algorithm described above, the server 130 may select the “ID” field from the fields in the original data item poi0, the “name” field from the fields in the original data item poll, the “address” field from the fields in the original data item poi2, the “longitude” field from the fields in the original data item poi3, the “latitude” field from the fields in the original data item poi4, and the “alias” field from the fields in the original data item poi5. The server 130 may then generate the replacement data item by combining the content corresponding to the “ID” field in the original data item poi0, the content corresponding to the “name” field in the original data item poll, the content corresponding to the “address” field in the original data item poi2, the content corresponding to the “longitude” field in the original data item poi3, the content corresponding to the “latitude” field in the original data item poi4, and the content corresponding to the “alias” field in the original data item poi5. Therefore, the content corresponding to the “ID” field of the replacement data is the content corresponding to the “ID” field of the original data item poi0, the content corresponding to the “name” field of the replacement data is the content corresponding to “name” field of the original data item poll, the content corresponding to the “address” field of the replacement data is the content corresponding to “address” field of the original data item poi2, the content corresponding to the “longitude” field of the replacement data is the content corresponding to “longitude” field of the original data item poi3, the content corresponding to the “latitude” field of the replacement data is the content corresponding to “latitude” field of the original data item poi4, and the content corresponding to the “alias” field of the replacement data is the content corresponding to “alias” field of the original data item poi5.

Alternatively, in some embodiments, the server 130 may select the six types of fields from the fields included in one of the six original data items. For example, the server 130 may select the “ID” field from the original data item poi0, the “name” field from the original data item poi0, the “address” field from the original data item poi0, the “longitude” field from the original data item poi0, the “latitude” field from the original data item poi0, and the “alias” field from the original data item poi0. The server 130 may then generate the replacement data item by combining the content corresponding to the “ID” field in the original data item poi0, the content corresponding to the “name” field in the original data item poi0, the content corresponding to the “address” field in the original data item poi0, the content corresponding to the “longitude” field in the original data item poi0, the content corresponding to the “latitude” field in the original data item poi0, and the content corresponding to the “alias” field in the original data item poi0. In some case, the server 130 may select the six types of fields from the fields included in two (or three, four, or five) of the six original data items. For example, the server 130 may select one part of the six types of fields from the fields included in the original data item poi0, and another part of the six types of fields from the fields included in the original data item poll. Merely by way of example, the server 130 may select the “ID” field, “name” field and “address” field from the original data item poi0, and the “longitude” field, “latitude” field, and “alias” field from the original data item poll. The server 130 may then generate the replacement data item by combining the contents corresponding to the “ID” field, “name” field and “address” field in the original data item, and the contents corresponding to the “longitude” field, “latitude” field, and “alias” field in the original data item poll.

In some embodiments, each of the at least two original data items may include only a part of the L types of fields. During the generation of the replacement data item, the server 130 may select the L types of fields from the fields included in the at least two original data items. The server 130 may then generate the replacement date item by combining the contents corresponding to the L types in the at least two original data items, respectively. For example, each of the N data items may include “A” field, “B” field, “C” field, and “D” field. The at least two original data items may include a first original data item, a second original data item, and a third original data item. The first original data item may include the “A” field, the “B” field, and the “C” field. The second original data item may include the “A” field, the “B” field, and the “D” field. The third original data item may include the “B” field, the “C” field, and the “D” field. During the generation of the replacement data item, merely by way of example, the server 130 may select the “A” field from the first original data item, the “B” field and the “C” field from the second original data item, and the “D” field from the third original data item. The server 130 may then generate the replacement data item by combining the content corresponding to the “A” field in the first original data item, the contents corresponding to the “B” field and the “C” field in the second original data item, and the content corresponding to the “D” field in the third original data item. It should be noted that the above description of the generation of the replacement data item is merely provided for the purposes of illustration, and not intended to limit the scope of the present disclosure.

The replacement data item generated by the above method may include the L types of fields, i.e., the types of fields included in replacement data item are the same as the types of field included in the corresponding data item of the N data item and thus, increasing the difficulty for the data acquirer to identify real or false of the data received by the data acquirer. Moreover, the content corresponding to at least one of the L types of field of the replacement data item is different from the content corresponding to the same type of field of the corresponding data item of the N data items. Therefore, it can be ensured that the data (i.e., the N replacement data items) transmitted by the server 130 to the device is false data, so that the effect of data protection is more effective. Furthermore, since there is no direct relationship between the replacement data item and the corresponding data item of the N data items, the above method may avoid the phenomenon that the data acquirer deduces corresponding data item of the N data items based on the replacement data item.

In step 1112, the server 130 (e.g., the processing device 132, the data protection apparatus 800, the data protection apparatus 900, the transmission module 808, the processor 210, and/or the interface circuits 210-1) may transmit N replacement data items to the device. The server 130 may generate the N replacement data items (i.e., false data) corresponding to the N data items (real data), respectively. The server 130 may then transmit the N replacement data items to the device. The data acquirer may acquire the N replacement data items through the device. In some embodiments, if N is equal to M, the server 130 may generate and transmit the M (or N) replacement data items to the device, which indicates that the server 130 may transmit false data to the device. In some embodiments, if N is less than M, the server 130 may generate the N replacement data items and transmit the N replacement data items and M-N data item(s) to the device, which indicates that the server 130 may transmit both false data (i.e., the N replacement data items) and real data (i.e., the M-N data item(s)) to the device and thus, increasing the difficulty of data identification by the data acquirer.

In some embodiments, if N is less than M, the server 130 may determine a weight value of each of the M data items based on the number of times that each of the M data items is accessed. The sever 130 may then determine the N data items (i.e., false data) and M-N data item(s) (i.e., real data) based on the weight values. In some embodiments, the server 130 may determine the weight value of each of the M data items based on the number of times that each of the M data items is accessed within a preset time period (e.g., the past day, the past two days, the past week, etc.). The more the number of times that a data item of the M data items is accessed within the preset time period, the larger the weight value of the data item may be. The weight value of a data item in the M data items may indicate the importance of the data item in the M data items. The larger the weight value is, the higher the importance of the corresponding data item may be. The smaller the weight value is, the lower the importance of the corresponding data item may be.

In some embodiments, the server 130 may rank the determined weight values in ascending order. The server 130 may then determine the data items corresponding to the top M-N weight values as real data. The server 130 may then transmit the M-N data item(s) (i.e., real data) and the N replacement data items (i.e., false data) to the device. In some embodiments, the server 130 may also select the M-N data item(s) (i.e., real data) based on the determined weight values according to uniform sampling. The present disclosure is not intended to be limiting in the aspect of determining the M-N data item(s).

In some embodiments, the server 130 may directly transmit the N replacement data items (and/or the M-N data item(s)) to the device. For example, the server 130 may directly transmit the N replacement data items (and/or the M-N data item(s)) to the terminal device 110 via, for example, the network 120. In some embodiments, the server 130 may carry the N replacement data items (and/or the M-N data item(s)) in a data acquisition response and transmit the data acquisition response to the device. The device may then acquire the N replacement data items (and/or the M-N data items) in the received data acquisition response.

The process 1100 for data protection provided by the embodiments of the present disclosure may determine the M data items to be acquired by the device based on the data acquisition request after receiving the data acquisition request transmitted by the device. The process 1100 may also determine the sender of the data acquisition request before the determination of the M data items to be acquired by the device. If the data acquisition request is an abnormal request transmitted by a data acquirer, the process 1100 may generate the replacement data item corresponding to each of the N data items in the M data items, and transmit the N replacement data items (i.e., false data) to the device. If N is less than M, the process 1100 may also transmit M-N data item(s) to the device. Therefore, the process 1100 may mislead the data acquirer and make the data acquirer fail to identify or need to spend a large cost to identify real or false of the data received by the data acquirer and thus, improving the effect of data protection. Furthermore, the process 1100 may select the L types of fields from the fields included in the original data items that are the same as the types of fields of the corresponding data item in the N data items to generate the replacement data item and thus, increasing the difficulty for the data acquirer to identify real or false of the data received.

It should be noted that the above description is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure or characteristic described in connection with the embodiment is included in at least one embodiment of the present disclosure. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the present disclosure.

Further, it will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “unit,” “module,” or “system.” Furthermore, aspects of the present disclosure may take the form of a computer program product embodied in one or more computer readable media having computer readable program code embodied thereon.

A computer readable signal medium may include a propagated data signal with computer readable program code embodied therein, for example, in baseband or as part of a carrier wave. Such a propagated signal may take any of a variety of forms, including electro-magnetic, optical, or the like, or any suitable combination thereof. A computer readable signal medium may be any computer readable medium that is not a computer readable storage medium and that may communicate, propagate, or transport a program for use by or in connection with an instruction execution system, apparatus, or device. Program code embodied on a computer readable signal medium may be transmitted using any appropriate medium, including wireless, wireline, optical fiber cable, RF, or the like, or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB. NET, Python or the like, conventional procedural programming languages, such as the “C” programming language, Visual Basic, Fortran 2103, Perl, COBOL 2102, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Furthermore, the recited order of processing elements or sequences, or the use of numbers, letters, or other designations therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software only solution, e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various inventive embodiments. This method of disclosure, however, is not to be interpreted as reflecting an intention that the claimed subject matter requires more features than are expressly recited in each claim. Rather, inventive embodiments lie in less than all features of a single foregoing disclosed embodiment.

In some embodiments, the numbers expressing quantities or properties used to describe and claim certain embodiments of the application are to be understood as being modified in some instances by the term “about,” “approximate,” or “substantially.” For example, “about,” “approximate,” or “substantially” may indicate ±20% variation of the value it describes, unless otherwise stated. Accordingly, in some embodiments, the numerical parameters set forth in the written description and attached claims are approximations that may vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the application are approximations, the numerical values set forth in the specific examples are reported as precisely as practicable.

Each of the patents, patent applications, publications of patent applications, and other material, such as articles, books, specifications, publications, documents, things, and/or the like, referenced herein is hereby incorporated herein by this reference in its entirety for all purposes, excepting any prosecution file history associated with same, any of same that is inconsistent with or in conflict with the present document, or any of same that may have a limiting affect as to the broadest scope of the claims now or later associated with the present document. By way of example, should there be any inconsistency or conflict between the description, definition, and/or the use of a term associated with any of the incorporated material and that associated with the present document, the description, definition, and/or the use of the term in the present document shall prevail.

In closing, it is to be understood that the embodiments of the application disclosed herein are illustrative of the principles of the embodiments of the application. Other modifications that may be employed may be within the scope of the application. Thus, by way of example, but not of limitation, alternative configurations of the embodiments of the application may be utilized in accordance with the teachings herein. Accordingly, embodiments of the present application are not limited to that precisely as shown and described.

1. A method for processing data requests implemented on a computing device having at least one processor, at least one storage device, and a communication platform connected to a network, the method comprising:
receiving a data request transmitted by a data requester, the data request being used to request to acquire a data resource;
determining whether the data requester has a permission to acquire the data resource; and
prohibiting a server to respond to the data request, if the data requester has no permission to acquire the data resource.

2. The method of claim 1, wherein the determining whether the data requester has the permission to acquire the data resource includes:
obtaining a suspicious user record that is previously stored; and
determining whether the data requester has the permission based on the suspicious user record.

3. The method of claim 2, wherein the determining whether the data requester has the permission to acquire the data resource based on the suspicious user record includes:
if a user identifier of the data requester is recorded in the suspicious user record, obtaining an occurrence time of a suspicious event corresponding to the user identifier from the suspicious user record; and
determining whether the data requester has the permission based on the occurrence time of the suspicious event.

4. The method of claim 3, wherein the determining whether the data requester has the permission based on the suspicious event occurrence time includes:
determining a current time;
determining a suspicious coefficient based on the current time and the occurrence time of the suspicious event; and
if the suspicious coefficient is greater than or equal to a preset value, determining that the data requester does not have the permission.

5. The method of claim 4, wherein the suspicious coefficient is negatively correlated with a target time interval, and the target time interval is a time interval between the current time and the occurrence time of the suspicious event.

6. The method of claim 2, further comprising:
obtaining a data request log for the data resource within a preset time period;
determining a suspicious user within the preset time period based on the data request log; and
creating or updating the suspicious user record based on the suspicious user within the preset time period.

7. The method of claim 6, wherein the determining the suspicious user within the preset time period based on the data request log includes:
determining a user, in the data request log, whose number of requests being greater than or equal to a preset number of times, as the suspicious user within the preset time period.

8. The method of claim 7, wherein the determining the suspicious user within the preset time period based on the data request log further includes:
obtaining, based on the data request log, the number of time period distributions corresponding to data requests generated by candidate users, wherein the number of data requests generated by each of the candidate users is less than the preset number of times; and
determining a candidate user, whose number of time period distributions being greater than a first threshold, as the suspicious user within the preset time period.

9. The method of claim 7, wherein the determining the suspicious user within the preset time period based on the data request log further includes:
obtaining, based on the data request log, the number of city distributions corresponding to data requests generated by candidate users, wherein the number of data requests generated by each of the candidate users is less than the preset number of times; and
determining a candidate user, whose number of city distributions being greater than a second threshold, as the suspicious user within the preset time period.

10. A method for data protection implemented on a computing device having at least one processor, at least one storage device, and a communication platform connected to a network, the method comprising:
receiving a data acquisition request transmitted by a device;
determining M data items to be acquired by the device based on the data acquisition request;
generating a replacement data item corresponding to each of N data items in the M data items, wherein N is less than or equal to M, M and N are positive integers; and
transmitting N replacement data items to the device.

11. The method of claim 10, wherein the generating the replacement data item corresponding to each of the N data items in the M data items includes:
determining L types of fields of each of the N data items;
collecting at least two original data items, each of the least two original data items including at least one of the L types of fields; and
generating the replacement data item based on fields included in the at least two original data items, wherein the replacement data item includes the L types of fields, and a content corresponding to at least one of the L types of fields of the replacement data item is different from a content corresponding to the same type of field of a corresponding data item of the N data items,
wherein L is a positive integer.

12. The method of claim 11, wherein the generating the replacement data item based on the fields included in the at least two original data items includes:
selecting the L types of fields from the fields included in the at least two original data items; and
generating the replacement data item by combining contents corresponding to the L types of fields in the at least two original data items, respectively.

13. The method of claim 10, wherein if N is less than M, the method further comprises:
transmitting M-N data items to the device.

14. The method of claim 13, further comprising:
determining a weight value of each of the M data items based on the number of times that each of the M data items is accessed; and
determining the M-N data items based on the weight values.

15. The method of claim 10, wherein the data acquisition request includes a device identifier of the device, and the method further comprises:
determining whether the device identifier is in a preset blacklist before the determination of the M data items to be acquired by the device based on the data acquisition request.

16. The method of claim 10, wherein the transmitting the N replacement data items to the device includes:
transmitting a data acquisition response to the device, the data acquisition response including the N replacement data items.

17-36. (canceled)

37. A system, comprising:
at least one storage device storing a set of instructions for processing data requests; and
at least one processor configured to communicate with the at least one storage device, wherein when executing the set of instructions, the at least one processor is configured to direct the system to perform operations including:
receiving a data request transmitted by a data requester, the data request being used to request to acquire a data resource;
determining whether the data requester has a permission to acquire the data resource; and
prohibiting a server to respond to the data request, if the data requester has no permission to acquire the data resource.

38. The system of claim 37, wherein the determining whether the data requester has the permission to acquire the data resource comprises:
obtaining a suspicious user record that is previously stored; and
determining whether the data requester has the permission based on the suspicious user record.

39. The system of claim 38, wherein the determining whether the data requester has the permission to acquire the data resource based on the suspicious user record comprises:
if a user identifier of the data requester is recorded in the suspicious user record, obtaining an occurrence time of a suspicious event corresponding to the user identifier from the suspicious user record; and
determining whether the data requester has the permission based on the occurrence time of the suspicious event.

40. The system of claim 39, wherein the determining whether the data requester has the permission based on the suspicious event occurrence time comprises:
determining a current time;
determining a suspicious coefficient based on the current time and the occurrence time of the suspicious event; and
if the suspicious coefficient is greater than or equal to a preset value, determining that the data requester does not have the permission.
